(19) United States
(12) Patent Application Publication
(10) Pub. No.: US 2024/0289745 A1
(43) Pub. Date: Aug. 29, 2024

(54) SYSTEMS, METHODS, AND COMPUTER READABLE MEDIA FOR OPERATIONALIZING SBOM CONTENT AND PROVIDING SBOM ANALYSIS

(71) Applicant: DEEPFACTOR, INC., San Jose, CA (US)

(72) Inventors: Michael Kevin Larkin, South Tahoe, CA (US); Vikas Wadhvani, Bangalore (IN); Naman Tandon, Bangalore (IN); Ashkay Menon, Bangalore (IN)

(21) Appl. No.: 18/442,298

(22) Filed: Feb. 15, 2024

Related U.S. Application Data
(60) Provisional application No. 63/487,040, filed on Feb. 27, 2023.
(60) Provisional application No. 63/508,064, filed on Jun. 14, 2023.

(51) Int. Cl. G06Q 10/0875

(52) U.S. Cl. CPC G06Q 10/0875

(57) ABSTRACT

Systems, methods, and computer-readable media for operationalizing standard bill of material (SBOM) content for software and providing SBOM analysis. Embodiments discussed herein can receive vulnerabilities from the at least one CVE source, determine whether the SBOM contains SBOM components associated with at least one of the vulnerabilities, and prevent an SBOM component from being used in an application build for the application when a vulnerability associated with that SBOM component exceeds a threshold.

### CROSS-REFERENCE TO RELATED APPLICATIONS

This application claims priority to U.S. Provisional Patent Application No. 63/487,040, filed Feb. 27, 2023, and U.S. Provisional Patent Application No. 63/508,064, filed Jun. 14, 2023, the disclosures of which are incorporated by reference in their entireties.

### TECHNICAL FIELD

This can relate to systems, methods, and computer-readable media for operationalizing standard bill of material (SBOM) content for software, providing SBOM analysis, and remediating vulnerabilities.

### BACKGROUND

Creation of a BOM (Bill of Materials) is a common and well accepted engineering practice in many engineering disciplines. A BOM contains a list of all the things necessary to build or produce an engineering work (building, machine, vehicle, computer, etc.). Maintaining a BOM in these engineering practices ensures that a rigorous process is followed to ensure that only approved components are used in a final assembly or product.

Software Bills of Material (SBOMs) are a way for software engineers to apply the same rigor to software engineering practices. Proper use of SBOMs can ensure that a software product's constituent components are vetted for proper sourcing, and that any defects (bugs or security vulnerabilities) are known to the software engineering practitioner.

Unfortunately, software engineering, as a discipline, has not relied upon BOMs until very recently, leading to unknown or possibly dangerous components being used in software products. This is due in part to developer ignorance of proper BOM procedure, as well as lack of sufficient, robust tooling to create and enforce BOMs during the product assembly phase (CI/CD pipeline).

The US government has mandated that all software products sold to it must have a proper, vetted SBOM as part of the sale, starting June 2023. This has necessitated the creation of unique solutions such as the one described herein, to assist development organizations with SBOM production and adherence to BOM requirements (e.g., rules associated with components with known vulnerabilities or down level versions).

Accordingly, what is needed is a more efficient and practical way to track and analyze SBOMs.

What is also needed is a way to provide remediation of vulnerabilities that are discovered during analysis of SBOMS.

### SUMMARY

Systems, methods, and computer-readable media for operationalizing SBOM content for software and providing SBOM analysis prioritizing vulnerability reports with telemetry events obtained during operation of an application. Embodiments discussed herein may also provide a way to remedy vulnerabilities discovered during the SBOM analysis.

This Summary is provided to summarize some example embodiments, to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 shows a schematic diagram of an example computer or server in accordance with an embodiment.

FIG. 2 shows a conventional flow of API calls originating from an application in a generic software stack.

FIG. 3 shows a flow diagram for intercepting calls at the API/library level according to an embodiment.

FIG. 4 shows an illustrative block diagram of how the application calls are intercepted, how event telemetry is collected, and how the application calls are executed according to an embodiment.

FIG. 5 shows an illustrative block diagram of an integrated loader according to an embodiment.

FIG. 6 shows an illustrative block diagram of an instrumentation module or system loading module according to an embodiment.

FIG. 7 shows an illustrative block diagram of a portal according to an embodiment.

FIG. 8 shows an illustrative block diagram of an analytics service according to an embodiment.

FIG. 9 shows how VEX can be used to reduce the number of reported vulnerabilities in an SBOM.

FIG. 10 shows a diagram highlighting how engineering teams can utilize the SBOM capabilities and use cases to enable developers, engineering leaders, and security teams to gather valuable supply chain information throughout every stage of the SDLC process.

FIG. 11 shows an illustrative GUI page showing SBOM data generated by the TIAP according to an embodiment.

FIG. 12 shows an illustrative GUI page showing SBOM vulnerabilities and dependencies generated by the TIAP according to an embodiment.

FIG. 13 shows an example contrasting conventional reporting by a convention system and enhanced SBOM reporting provided by the TIAP according to an embodiment.

FIG. 14 shows an illustrative block diagram of various modules being used in connection with a TIAP according to an embodiment.

FIG. 15 shows an illustrative process for evaluating SBOMs according to an embodiment.

FIGS. 16A and 16B show another illustrative process for evaluating SBOMs according to an embodiment.

FIG. 17 show an illustrative process for remediating vulnerable components identified in an SBOM according to an embodiment.

### DETAILED DESCRIPTION

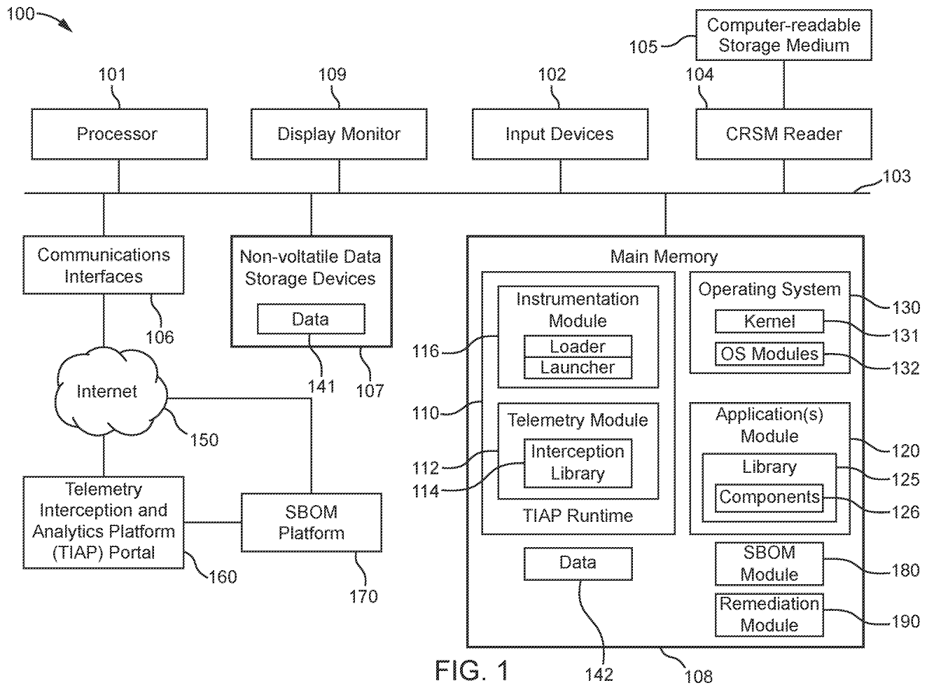

Systems, methods, and computer-readable media for operationalizing standard bill of material (SBOM) content for software and providing SBOM analysis and remediation of vulnerabilities during SBOM analysis with respect to monitored telemetry events are provided and described with reference to FIGS. 1-17. The operationalization of SBOMs, analysis thereof, and generation of vulnerability remediation is performed in conjunction with a telemetry interception and analysis platform.

The relationship between digital transformation and application modernization, and Open Source Software (OSS), has never been stronger. For example, according to a recent report, 97% of applications leverage open-source code. From encouraging collaboration to reducing costs and time-to-market, OSS fundamentally changes how an organization operates and delivers value to its customers. The transition to OSS means increased transparency and accessibility, which is helping to drive innovation and improve the overall quality of software. However, while OSS promises to simplify and accelerate software development, organizations continue to struggle with accurately and systematically recording and summarizing the massive volume of software they produce, consume, and operate. Without this visibility, software supply chains are vulnerable to the security and licensing compliance risks associated with software components. According to the November 2022 report by Gartner, How Software Engineering Leaders Can Mitigate Software Supply Chain Security Risks by analysts Manjunath Bhat, Dale Gardner, and Mark Horvath, “45% of organizations worldwide will have experienced attacks on their software supply chains by 2025, a three-fold increase from 2021.” To mitigate these attacks, engineering teams must assume all code—from external dependencies to commercial off the-shelf (COTS) software to internally developed code—may be compromised. This is the primary driver behind President Biden's Executive Order (EO) on Improving the Nation's Cybersecurity, which mandates accurate and in-depth reporting of software supply chains.

According to the Cybersecurity and Infrastructure Security Agency, “a software supply chain attack occurs when a cyber threat actor infiltrates a software vendor's network and employs malicious code to compromise the software before the vendor sends it to their customers. The compromised software then compromises the customer's data or system.” Several infamous supply chain attacks from the past several years are described below.

SolarWinds: Due to a breach in December 2020, roughly 18,000 customers of SolarWinds downloaded trojanized versions of its Orion IT monitoring and management software. The supply chain attack led to the breach of government and high-profile companies after attackers deployed a backdoor dubbed SUNBURST or Solorigate.

Octopus Scanner Malware: Octopus Scanner is a type of malware that finds and backdoors open-source NetBeans projects hosted on the GitHub web-based code hosting platform to spread to Windows, Linux, and macOS systems and deploy a Remote Administration Tool (RAT). The malware compromises developers' computers by infecting NetBeans repositories with malicious payloads within various dependencies, later spreading to downstream development systems.

Codecov provides tools that help developers measure how much of the source code executes during testing, which can help identify undetected bugs. In April 2021, a threat actor had modified the Codecov Bash Uploader script, exposing sensitive information in customers' continuous integration (CI) environments. This includes Rapid7, who revealed that some of their source code repositories and credentials were accessed by Codecov attackers.

Though some issues may be addressed by securing the underlying Kubernetes environment and its relevant attack surface; hardening the continuous integration and delivery (i.e. CI/CD) pipeline; or creating a culture to significantly improve your organization's security posture, the complexity of OSS development exacerbates security and compliance risks. Given the need for increased visibility and transparency into proprietary and open-source dependencies within the software supply chain, software engineering teams need the tools and development processes to systematically discover and manage multiple layers of dependencies and potentially vulnerable software packages.

According to National Telecommunications and Information Administration (NTIA), a Software Bill of Materials (SBOM) “is a complete, formally structured list of components, libraries, and modules that are required to build (i.e. compile and link) a given piece of software and the supply chain relationships between them. These components can be open source or proprietary, free or paid, and widely available or restricted access.” In other words, SBOMs enable greater transparency, auditability, and accountability, helping engineering teams detect malicious attacks and vulnerable code throughout the software development lifecycle.

Embodiments discussed herein help engineering teams understand and identify the core components and capabilities of SBOMs responsible for addressing the many challenges introduced by the increased adoption of OSS across digital transformation and application modernization initiatives. In doing so, enterprises should be prepared to meet regulatory demands, such as within President Biden's Executive Order, for in-depth reporting and analysis of their software supply chain.

With organizations responsible for verifying and securing software supply chains-open source, proprietary, third-party code alike-engineering leaders across development, security, and compliance need help managing the balance between mitigating product security and supply chain risk, while shortening time-to-market, automating incident and remediation response, and assisting with compliance requirements.

According to Gartner's 2022 Innovation Insight for SBOMs Report, SBOMs “represent a critical first step in discovering vulnerabilities and weaknesses within your products and the devices you procure from your software supply chain.” SBOMs “improve the visibility, transparency, security, and integrity of proprietary and open-source code in software supply chains.” In other words, SBOMs enable organizations to expose and manage the risk inherent in the vast amounts of code they create, consume and operate. There are many reasons why organization and companies should consider implementing a SBOM. Five of these reasons are discussed below.

Maintain compliance: Many industries and government agencies have regulations (e.g., President Biden's Executive Order) in place requiring organizations to maintain a certain level of transparency and security in software supply chains. SBOMs can help developers meet compliance requirements by providing a clear and accurate record of the software components and dependencies used within an application. This can include information on the origins and versions of those components, as well as licensing and end-of-life information.

Improve Security: By having a comprehensive understanding of the software components that make up an application, organizations can identify, address and/or mitigate potential security vulnerabilities and risks more effectively. This can include identifying and patching vulnerabilities, replacing insecure components with more secure alternatives, or removing unnecessary components that increase the attack surface of an application unnecessarily.

Satisfy Customer Requirements: Driven in part by a legislation to help secure open-source software, Gartner reports in Innovation Insights for SBOMs by analysts Manjunath Bhat, Dale Gardner, Mark Horvath, “By 2025, 60% of organizations procuring mission-critical software solutions will mandate SBOM disclosures in their license and support agreements, up from less than 5% in 2022.” This requirement should be seen as a forcing-function behind the growing demand for increased supply chain transparency and disclosure by customers. By addressing these requirements, organizations can ensure competitiveness with other software vendors offering SBOMs.

Minimize Financial Consequences: Insecure software supply chains greatly increase the chance and/or impact of security incidents such as data breaches, zero-day vulnerabilities, and privacy violations. With the average data breach costing businesses in the United States $9.05 Million, SBOMs ensure organizations can identify and eliminate unnecessary “risks” in the software supply chain, helping to avoid expensive consequences in the future.

Enhance Communication and Collaboration: SBOMs can be shared amongst various personas (e.g. AppSec, Developers, Compliance Officers, etc.) providing a common understanding of the software components and dependencies being used across the engineering organization. SBOMs are a key component of the vulnerability scanning process, providing the information necessary to quickly remediate and/or mitigate application security risks, improving the ROI and time-savings promised through DevSecOps.

In July 2021, the Department of Commerce and NTIA published a report to identify and define “the essential pieces that support basic SBOM functionality and will serve as the foundation for an evolving approach to software transparency.” These minimum elements are comprised of three broad, interconnected areas of focus: Data Fields (e.g., Document baseline information about each component that should be tracked: Supplier, Component Name, Version of the Component, Other Unique Identifiers, Dependency Relationship, Author of SBOM Data, and Timestamp), Automation Support (e.g., Support automation, including via automatic generation and machine-readability to allow for scaling across the software ecosystem. Data formats used to generate and consume SBOMs include SPDX, CycloneDX, and SWID tags), and Practices and Processes (e.g., Define the operations of SBOM requests, generation, and use including: Frequency, Depth, Known Unknowns, Distribution and Delivery, Access Control, and Accommodation of Mistakes). The objective of these minimum elements is twofold: 1) enable basic use cases, such as management of vulnerabilities, software inventory, and licenses, during which 2) advanced and recommended SBOM features can be prioritized and developed to enable broader, more secure use cases and reporting of supply chain data. According to both the EO and the pursuant report, SBOMs should provide a structured, scalable, and robust way to increase trust and security in software supply chains that “span organizational boundaries, product lines, vendors, partners and nations.”

In order to support automation-providing engineering teams with a mechanism to implement and scale solutions across the software supply chain-SBOM tooling requires predictable implementation, and machine and human-readable data formats. Though a single standard may provide simplicity and efficiency, according to the report, “multiple data formats exist in the ecosystem and are being used to generate and consume SBOMs. These specifications have been developed through open processes, with international participation . . . and have been deemed interoperable for the core data fields and use common data syntax representations.” There are three main SBOM formats: CycloneDX (e.g., CycloneDX is a lightweight SBOM standard designed for use in application security contexts and supply chain component analysis. CycloneDX started in the Open Web Application Security Project), Software Package Data Exchange (SPDX) (e.g., The SPDX specification was developed by the open source software development community and is supported by a rich ecosystem of open-source tools and commercial providers. SPDX became the internationally recognized standard (ISO/IEC 5962:2021) for SBOMs in September 2021), and Software Identification (SWID) (e.g., SWID tags were designed to provide a transparent way for organizations to track their software inventory on managed devices. SWID tags contain descriptive information about a specific software release such as the product and version. NIST recommends adoption of the SWID Tag standard by software producers, and multiple standards bodies (e.g., IETF), and is working to incorporate SWID tag data into the National Vulnerability Database (NVD)).

The primary objective of the Vulnerability Exploitability Exchange (VEX) is to provide engineering teams with the information necessary to determine whether a product is impacted by a specific vulnerability discovered in a dependency or operating system package. According to an overview produced by the NTIA, “a vulnerability in an upstream component [may] not be ‘exploitable’ in the final product for various reasons (e.g., the affected code is not loaded by the compiler).” However, assuming there is potential impact, VEX should help determine the recommended actions for remediation.

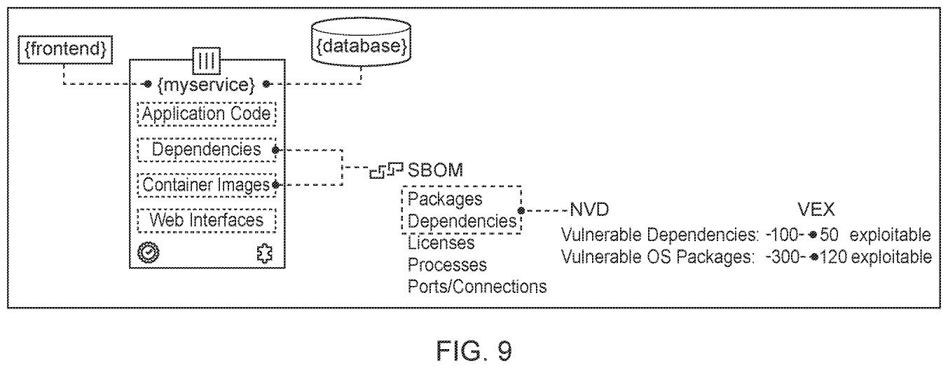

When combined with information provided within an SBOM, VEX can help engineering and security teams better manage and triage issues by helping identify which vulnerabilities are exploitable. FIG. 9 shows how VEX can be used to reduce the number of reported vulnerabilities in an SBOM. For example, as shown in FIG. 9, 100 vulnerable dependencies and 300 vulnerable OS packages are identified, but application of the VEX identifies that 50 of the vulnerable dependencies are exploitable and that 120 of the vulnerable OS packages are exploitable.

Though many organizations have successfully navigated the transition to DevOps, addressing security challenges in cloud native applications remains a major challenge. To address these challenges, over 60% of organizations have started to incorporate security throughout the software development lifecycle (SDLC). The drivers behind “shifting left” are obvious-engineering teams are responsible for driving the business; therefore information security must adapt to development processes and tools, not the other way around.

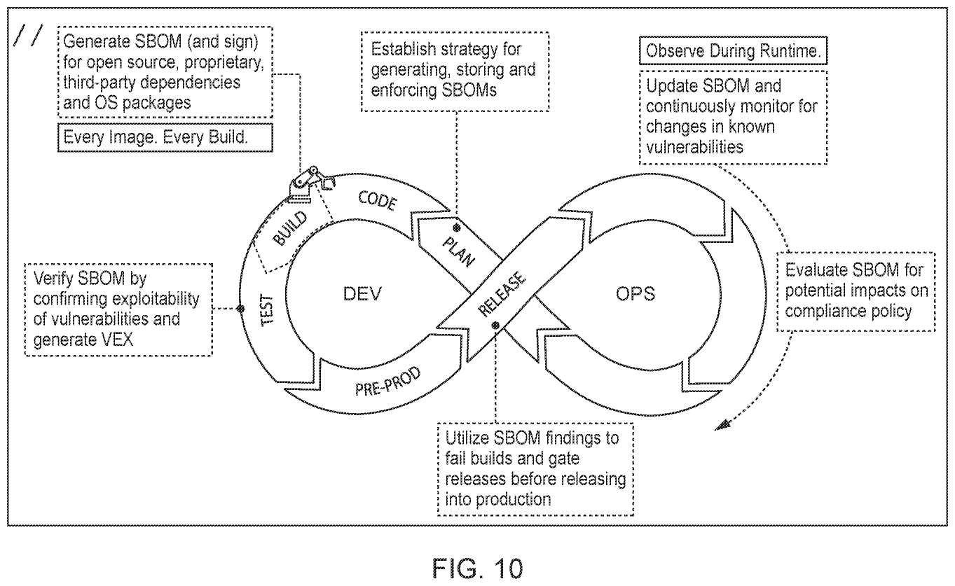

In order to start addressing these challenges, organizations should consider the implementation of SBOMs to help drive the adoption and maturity of DevSecOps. By providing a clear and up-to-date inventory of all the third-party components used in a software project, developers can use this information to identify any known vulnerabilities in the components, which can then be prioritized and mitigated before releasing into production. Additionally, by integrating SBOMs into the development process, organizations can improve their ability to remove unused components to reduce the overall attack surface, prioritize vulnerabilities based on the potential impact and likelihood of exploitation, remediate and/or replace vulnerable components, comply with industry regulations and laws that require the reporting of vulnerabilities in software, such as the Cybersecurity Information Sharing Act (CISA) and the General Data Protection Regulation (GDPR), report on the security posture of the software to stakeholders, such as security teams, compliance officers, and auditors, and prevent builds with a risk profile from releasing into production. FIG. 10 shows a diagram highlighting how engineering teams can utilize the SBOM capabilities and use cases to enable developers, engineering leaders, and security teams to gather valuable supply chain information throughout every stage of the SDLC process.

Regardless of the standards and guidelines-implementing an organization-wide program to generate, review, and operationalize SBOMs remains challenging. This is particularly true when you consider “7 in 10 DevOps teams (70%) release code continuously” (defined as once a day, or every few days) and, on average, 57% of enterprises are using 11 or more containers per application. Given this pace of releases, SBOMs can have several shortcomings which may limit usefulness for an organization. For example, SBOMs may have limited visibility in that they do not provide a comprehensive view of every component in a software system-such as open ports, running processes, network connections and privilege escalations. As another example, SBOMs can be inaccurate because they are highly-dependent on the source and the process (i.e. when, where and how) by which the report is generated. This can lead to missing data and quality issues. SBOMs can be noisy because they generate large amounts of data-including a number of false positives-which can overwhelm the developers and security teams responsible for triaging. SBOMs can produce inconsistent and incompatible reports, particularly when the previously mentioned standards and data formats aren't strictly observed. Furthermore, SBOMs are challenging to integrate, particularly in modern pipelines where development and operations are completely automated and happening at-scale.

In order to manage these challenges, leaders across engineering, security and operations must carefully evaluate SBOM platforms to determine which products have the right combination of features, code coverage, and even instrumentation to ensure developers have the contextual security information necessary to prioritize the resolution of critical security risks. TIAP enabled SBOM evaluation module according to embodiments discussed herein can generate and store standards-based SBOMs during development, can directly address the aforementioned challenges, and can enable organizations to comply with the Executive Order pertaining to SBOMs. The TIAP enabled SBOM evaluation module can help developers and security engineers efficiently deliver secure code.

As defined herein, an alert is an abnormal condition that has been identified by an analytics service, based on a rule defined in an alert grammar.

As defined herein, an alert grammar includes a set of rules or parameters that are used to classify telemetry events obtained by a telemetry interception and analysis platform (TIAP) during operation of an application. The set of rules can be part of default set of rules provided by the TIAP, generated by a customer using the TIAP, heuristically learned rules created by machine learning, or any combination thereof. Other grammars may be used by the TIAP such as, for example, insight grammars, performance grammars, and warning grammars. Yet other grammars can include compliance grammars that search telemetry data for specific items such as, for example, credit card numbers, personally identifiable information (PII), addresses, bank accounts, etc.

As defined herein, an analytics service refers to one of many services handled by the TIAP and operative to perform analytics and telemetry events collected from an application. The analytics service may reference an alert grammar, insight grammar, performance grammar, or any other grammar to evaluate collected telemetry events.

As defined herein, an application refers to a top hierarchy level of monitoring by the TIAP. An application includes one or more component groups and represents a complete implementation of a top-line business application.

As defined herein, an API Server is a service that implements endpoint APIs (REST-based) for use by user interface (UI) and command line interface (CLI) tools.

As defined herein, a blueprint service analyzes recorded telemetries for one or more components and creates alert rules based on what has been seen. The blueprint service can be used to define behavioral blueprints that describe the intended behavior of an application (e.g., how an application should be behave, what it should do, and what it should not do).

As defined herein, a component is abstract definition of a single type of process known to the platform (e.g., “database” or “web server”). An application can operate using one or more components.

As defined herein, a component instance is an individual concrete example of a component, running on a specific host or a virtual machine (e.g., “database running on myserver.corp.com”). One or more instances may occur for each component.

As defined herein, a component group is a collection of all instances of a given component (e.g., “all databases in application x”).

As defined herein, a common vulnerability and exposure (CVE) is a system that provides a reference-method for publicly known information-security vulnerabilities and exposures. The National Cybersecurity FFRDC, operated by the Mitre Corporation, maintains the system, with funding from the National Cyber Security Division of the United States Department of Homeland Security. The system was officially launched for the public in September 1999. The Security Content Automation Protocol uses CVE, and CVE IDs are listed on MITRE's system as well as in the US National Vulnerability Database.

As defined herein, a CVE service is a platform service that periodically ingests CVE metadata and analyzes if any components are vulnerable to any known CVEs.

As defined herein, a dashboard can refer to a main screen of a TIAP portal UI.

As defined herein, an event service is a service that responds to telemetry event submissions using a remote call (e.g., gRPC or representational state transfer (REST)) and stores those events in an events database.

As defined herein, a housekeeping service is a service that periodically removes old data from logs and databases.

As defined herein, an insight is a noncritical condition that has been identified by the analytics service, based on a rule defined in a grammar. Insights are typically suggestions on how performance or other software metrics can be improved, based on observed telemetries.

As defined herein, a native library refers to a collection of components or code modules that are accessed by the application.

As defined herein, an interception library is created by the TIAP and is used to intercept API calls by the application and record the API calls as a telemetry event. The interception library can trampoline the original API call to the native library. The interception library can include the same functions of the native library or subset thereof and any proprietary APIs, but is associated with analysis platform and enables extraction of telemetry events related to operation of the application. When a function is called in the interception library, the telemetry event collection is performed and actual code in the native library is accessed to implement the function call.

As defined herein, a TIAP portal may refer to a Software as a Service (SaaS) or on-premise management server that host TIAP, including the dashboard and other TIAP UI screens, as well as any services required to set up installation of TIAP runtime code to monitor a customer's application, collect telemetry from the customer's application, and analyze collected telemetry.

As defined herein, a metric can refer to telemetry data collected that includes a numeric value that can be tracked over time (to form a trend).

As defined herein, a policy may be a security ruleset delivered to the runtime during initial communication/startup that describes desired tasks that are to occur when certain events are detected (e.g., block/allow/warn).

As defined herein, TIAP runtime or Runtime refers to a code module that runs within a loaded process' (component instance) address space and provides TIAP services (e.g., telemetry gathering, block actions, etc.).

As defined herein, a script may be downloadable program that a user can run in his or her environment to update all vulnerable components.

As defined herein, a system loader is software tool that combines a customer's executable code with the runtime code to produce a binary output that is then used in place of the original executable code.

As defined herein, a trampoline or trampoline function is a runtime internal technique of hooking/intercepting API/library calls used by a component.

As defined herein, a trend is a change of metric values over time.

As defined herein, a vulnerability report associates a known vulnerability (e.g., a CVE) with a function, module, component, or object called by an application.

As defined herein, a warning is an abnormal condition that may not be critical, that has been detected by the analytics service, based on a rule defined in an alert/insight/warning grammar.

FIG. 1 shows a schematic diagram of an example computer or server in accordance with an embodiment. The computer or server of FIG. 1 may have fewer or more components to meet the needs of a particular application. As shown in FIG. 1, the computer may include a processor 101. The computer may have one or more buses 103 coupling its various components. The computer may include one or more input devices 102 (e.g., keyboard, mouse), a computer-readable storage medium (CRSM) 105 (e.g., floppy disk, CD-ROM), a CRSM reader 104 (e.g., floppy drive, CD-ROM drive), a display monitor 109 (e.g., cathode ray tube, flat panel display), communications interfaces 106 (e.g., network adapters, modems) for communicating over computer networks, one or more non-volatile data storage devices 107 (e.g., hard disk drive, optical drive, FLASH memory), and a main memory 108 (e.g., RAM). Software embodiments may be stored in a computer-readable storage medium 105 for reading into a non-volatile data storage device 107 or main memory 108. Data may be stored in data storage device 107 as data 141 or memory 108 as data 142. Software embodiments may also be received over a network, such as Internet 150 by way of a communications interface 106. In the example of FIG. 1, main memory 108 includes many different software modules. Note that these software modules may also run in data storage locations other than main memory.

The operating system 130 may include a UNIX-like operating system, such as the Linux operating system, iOS operating system, Mac OSX operating, or Windows operating system. Operating system 130 can include a kernel 131 and operating system modules 132. Operating system modules 132 can include components of operating system 130 other than kernel 131.

Other modules can include TIAP runtime module 110, telemetry module 112, instrumentation module 116, applications module 120, SBOM module 180, and remediation module 190. Application module 120 may include computer-readable code for executing an application running on computer 100. The code may include executable code (e.g., a .exe file). Application module 120 may include a native library 125 (e.g., Libc.so) that is used during operation of the application. Native library 125 may include one or more components 126.

TIAP runtime module 110 may include computer readable code for executing operation of telemetry module 112 and instrumentation module 116, referred to herein as TIAP runtime or TIAP runtime code. TIAP runtime module 110 may include the TIAP runtime operative to collect telemetry events and provide the collected telemetry events to TIAP portal 160 via Internet 150.

Telemetry module 112 can include computer-readable code that is operative to intercept application programming interface (API) calls originating from the application at the library level within the software stack and capture such calls as telemetry events that are provided to TIAP 160 for further analysis. Telemetry module 112 may include an interception library 114. Interception library 114 may include interception code and trampoline functions corresponding to each component or API called by the application. The TIAP runtime can interpose on any function in any library used by any component by inserting interception hooks or trampoline functions into the application's dependency chain (e.g., IAT/PLT/GOT). These trampoline functions redirect control flow from the native library API functions to the TIAP runtime, which then collects information about the API request (parameters, call stack information, performance metrics, etc.) as telemetry events, and then passes the original call to the native library. The interception code is responsible for collecting the parameters needed for the telemetry event. Telemetry events can be continually monitored by the TIAP runtime. Each component instance is continually monitored by the TIAP runtime and the desired telemetry events are captured and sent to TIAP portal 160 Telemetry events can be collected into batches and periodically sent to the TIAP portal for later analysis. The batching capability of the platform runtime can be further subdivided into prioritized batches—this entails creating multiple event queues that are sent with varying priorities to TIAP portal 160. This subdivision is useful in scenarios where the runtime is only allotted a small amount of CPU/memory/network bandwidth (as to not to interfere with efficient application execution). In the case where events may be dropped (due to not having sufficient resources), the TIAP runtime can instead collect a count of “missed events” that can be later communicated to the management platform when resources are available. This count provides the system administrator with a sense of how many events may be missing from the overall report provided by TIAP portal 160.

Instrumentation module 116 may be operative to load or package the necessary files and/or library associated with an application with files and/or library associate with platform 118 into a loader, launcher, or executable file that enables telemetry module 112 to extract telemetry events from the application during TIAP runtime.

SBOM module 180 may be operative to monitor, log, and assess vulnerabilities of components being used by an application.

Remediation module 190 may be operative to locate and provide updates for problematic components identified by SBOM module 180. The component updates can be packaged and provided to the user of the application to download and install so that problematic components are replaced with updated versions thereof.

TIAP portal 160 may perform analytics on the collected telemetry events and generate visuals for display to users of computer 100 based on the analytics obtained from the analysis of the application.

SBOM platform 170 may operate in connection with or independently of TIAP portal 160. SBOM platform 170 may leverage TIAP runtime data and SBOM data to generate visuals related to the SBOM. In some embodiments, platform 170 may enable a user download updated component versions identified by remediation module 190.

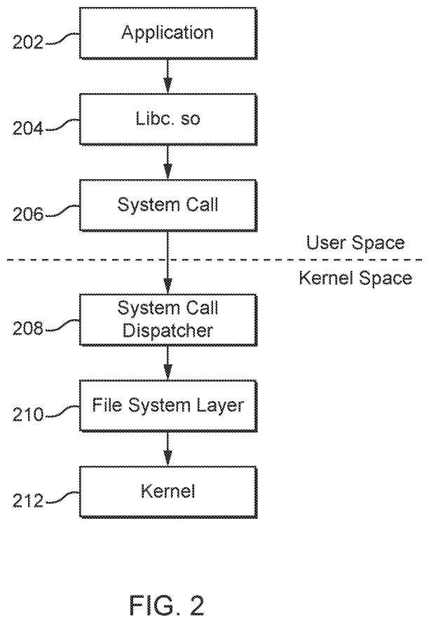

FIG. 2 shows a conventional flow of API calls originating from an application in a generic software stack. System memory in UNIX-like operating systems may be divided into two distinct regions, namely kernel space and user space. FIG. 2 shows the user space and the kernel space demarcated by the dashed line. Kernel space is where the kernel executes and provides its services. User space is where a user process (i.e., all processes other than the kernel) executes, a process being an instance of an executing program. The kernel manages individual user processes within the user space and prevents them from interfering with each other. A user process typically cannot access kernel space or another user process's user space. However, an active user process may access kernel space by invoking a system call.

Starting with block 202, an application can make an application programming interface (API) call (e.g., open, write, read, etc.). That call is passed to block 204 where a library (e.g., Libc.so) is accessed to execute the API call. The library can contain subroutines for performing system calls or other functions. At block 206, a system call is invoked. The system call may be a modification of an existing system call available from the operating system. For example, the system call may be a modified version of the ioctl system call. The system call may be invoked by filling up register values then asserting a software interrupt that allows trapping into kernel space. For example, block 206 may be performed by a C language program that runs in the Linux operating system. The C language program may move the system call's number into the register of a processor and then assert an interrupt. The invocation of the system call can be made using a programming language's library system call interface. In one embodiment, the invocation of the system call is made using the C programming language's library system call interface.

In block 208, the invocation of the system call executes a trap to enter the kernel space. The system call dispatcher gets the system call number to identify the system call that needs to be invoked.

In block 210, the system call dispatcher vectors branches to the system call, which in the example of FIG. 2 involves a file operation. Accordingly, the system call is executed through the operating system's file system layer. The file system layer may be the Virtual File System (VFS) layer of the Linux operating system, for example. During blocks 208 and 210, the kernel stack gets populated with information that allows the processor to execute the instructions relating to the system call. Such information may include the return address of the system call and the system call table address. In block 212, the system call invoked in block 206 is executed in the kernel.

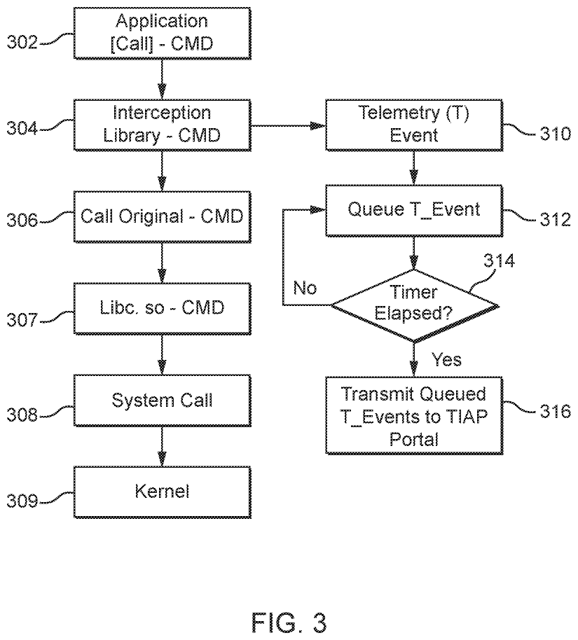

The TIAP according to embodiments discussed herein can intercept operations originating from the application at the library level of the software stack. This is in contrast with conventional hook operations that intercept at the system call level or somewhere within the kernel space, typically accessed using Extended Berkeley Packet Filter (eBPF). Hooks using eBPF are often subject to various issues such as software updates to parts of the software stack that require special permissions, administrator permissions, or lack of API assurance that can result in breaking the application. Therefore, to eliminate such issues, embodiments discussed herein intercept at the library level. Referring now to FIG. 3, a flow diagram for intercepting calls at the API/library level according to embodiments discussed herein is shown. Starting at block 302, an application makes an API call to execute a particular command (shown as CMD). The command is passed to an interception library at block 304. The interception library is interposed between the application call and the native library associated with the application (block 308). The application is programmed via an instrumentation or loading process (e.g., performed by instrumentation module 116) to interact with the interception library first before calling the original command with the native application.

The interception library can include the same functions of the native library or subset thereof and any proprietary APIs, but is associated with analysis platform and enables extraction of telemetry events related to operation of the application. When a function is called in the interception library, the telemetry event collection is performed and actual code in the native library is accessed to implement the function call. Telemetry events are shown in block 310. The interception library can enable all parameters of the API call to be recorded in a telemetry event. For example, if the API call is an OPEN command, the parameters can include file path, permissions, identification information, environmental information, etc. Since applications are continually monitored using embodiments discussed herein, telemetry events are constantly being collected and provided to the TIAP portal (e.g., portal 160). For example, the telemetry events may be queued at block 312 and batch transmitted to the analysis platform (block 316) each time a timer elapses at decision block 314. The TIAP portal can be run locally on the same device that is running the application or the analysis platform can be run remotely from the device running the application. In the remote case, the telemetry events may be transmitted via a network connection (e.g., the Internet) to the TIAP portal.

Telemetry events collected by the TIAP runtime can be buffered in memory into a lock-free queue. This requires little overhead during program execution as the telemetry upload occurs less frequently. The size of the event queue is determined by a setting periodically refreshed by the TIAP portal. The customer is permitted to set the amount of memory and CPU overhead that the TIAP runtime can consume. The TAP runtime can adjust the size of the event queue and the quality of data measured accordingly. In the case that events need to be dropped due to exceeding the allowed CPU/memory thresholds, a simple counter can be maintained to reflect the number of dropped events. When there is adequate resource available, the number of missed events is communicated to the TIAP platform. The buffer can be flushed periodically, depending on size and overhead constraints. This is done at event submission time (e.g., any event can potentially trigger a buffer flush). During flush, the events in the queue are batched and sent to an event service in the TIAP portal using REST or gRPC. The TIAP runtime can also support a high-priority queue, for urgent events/alerts.

The TIAP runtime may be required to handle special cases. The special cases can include handling signals, handling dynamic library loads, and handling fork and exec functions. Signal handling is now discussed. Telemetry events occurring during signal handling have to be queued in a way that uses no signal-unsafe APIs; this is the exception to the rule that that any event can cause a buffer flush. All trappable signals are caught by the runtime. The runtime increments counts of received signals for periodic upload to the management portal. To support the component's own use of signals, the runtime retains a list of any handlers the component registers using signation and invokes those handlers upon receiving a signal. This may require removing a stack frame before calling the handler.

The runtime intercepts calls to the dlsym, dlopen, and other dynamic library load routines. These loaded libraries are subject to the same telemetry grammar treatment as during initial load. Calls to these functions also may result in telemetry events of their own.

The fork and exec functions require special treatment. Fork can result in an exact copy of the process being created, including a TIAP runtime state. In order to support fork properly, the fork call is intercepted and the following sequence of operations is performed: a fork telemetry event is sent (if such a telemetry grammar exists), the child's event queues are cleared, and the child's instance ID is regenerated. This sequence of steps ensures that the TIAP portal sees a clean set of telemetries from the child. The exec function requires other special treatment. On exec, the following sequence of operations is performed: the original arguments to exec are preserved, the arguments to exec are changed to point to the current program (e.g., the program that is already loaded), with no command line arguments and an environment variable named DF_EXEC set to the original arguments supplied by the caller. As a result, the operating system re-executes the same program, causing the runtime to restart itself. Upon seeing DF_EXEC set, the runtime will launch the original program defined in the call to exec, with runtime protection.

Immediately after the application call is sent to block 304, the original call command is invoked at block 306. Calling the original command is necessary to allow the application to operate as intended. The operations in blocks 304, 306, 310, 312, 314, and 316 may be executed by TIAP runtime module 110 or telemetry module 112. The original call command accesses the native library at block 307. This leads to a system call at block 308, and then access to the kernel at block 309.

It should be understood the flowchart can be implemented in any process being used by a customer application product. For example, the flowchart can be implemented in a web server, a database, middleware, or any other suitable platform being used by the application. That is, the same interception library can be used in all processes. This enables a history of the stack trace to be captured and analyzed.

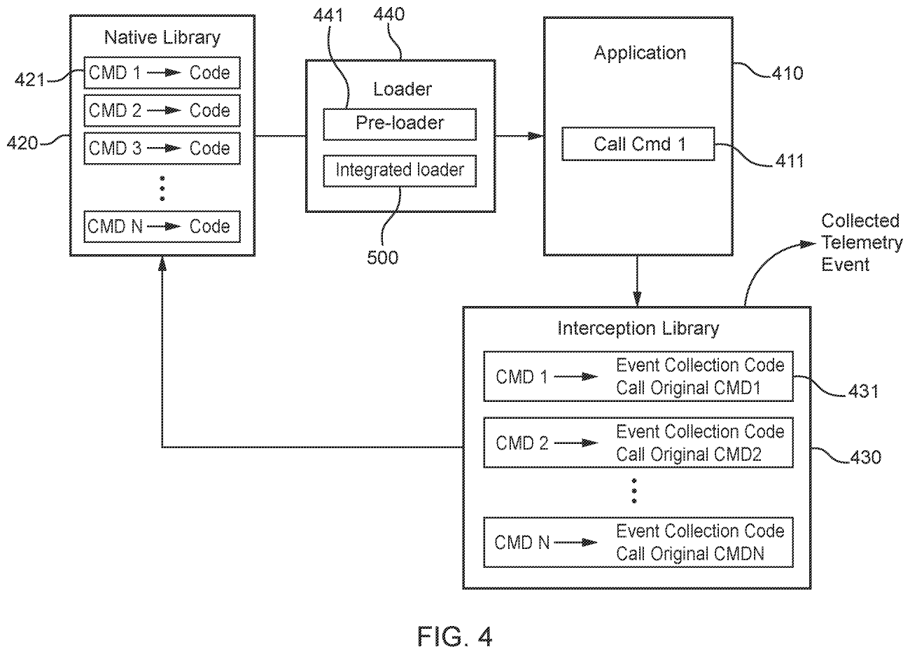

FIG. 4 shows an illustrative block diagram of how the application calls are intercepted, how event telemetry is collected, and how the application calls are executed according to an embodiment. The application is shown in block 410 and the native library associated with the application is shown in block 420. Native library 420 can include code for N number of commands, functions, or binaries (shown here as CMD1, CMD2, CMD3, and so on). Each command is associated with its own code (as shown) for implementing the command. When application 410 is running, it can call a command (e.g., call CMD1 411). FIG. 4 also shows an interception library in block 430. Interception library 430 can include a copy of each command contained in the native library. The copied commands may not contain the actual code of the native library commands but can include event collection code (or interception code) that enables telemetry associated with the application call to be collected. After the telemetry event is collected, the original command called by the application is called using a trampoline function. The interception code can include the trampoline function and telemetry grammars that define what parameters to collect. For example, assume application 410 calls CMD1 411. In response to call of CMD1 411, CMD1 431 in interception library 430 is accessed, and the telemetry event associated with call CMD1 411 is collected. After the event is collected, the original CMD1 421 is called using a trampoline function and the application call of CMD 411 is executed. In a trampoline function, call CMD1 411 initially goes to interception library 430 and then trampolines to native library 420.

Loader 440 can enable application 410 to load code in a library to be executed. For example, assuming that interception library is not present and the call CMD1 411 is called. The loader would load the code 421 in native library so that the CMD1 operation could be executed. However, in the embodiment illustrated in FIG. 4, interception library 430 is present and must be the first library accessed in response to a call by application 410. One way to ensure that interception library is accessed first is to set a pre-loader (e.g., preloader 441) to interception library 430. The pre-loader is commonly referred to as LD_PRELAOD. For example, LD_PRELOAD is set to Interception Library. This results in pre-loader instructing loader 440 to access interception library 430 first before accessing any other libraries such as native library 410.

An alternative to using a preloader is to use an integrated loader (e.g., integrated loader 500) for each application. This integrated loader can eliminate a few potential issues that may exist with using the preloader. For example, a customer could turn the preloader off, which would prevent telemetry collection because the interception library would not be accessed first. Another potential issue that can arise using the preloader is that other resources may use it, thereby potentially causing who goes first management issues. In addition, if an application uses static linking (e.g., where code in the native library is copied over to the application), the pre-loader will not work.

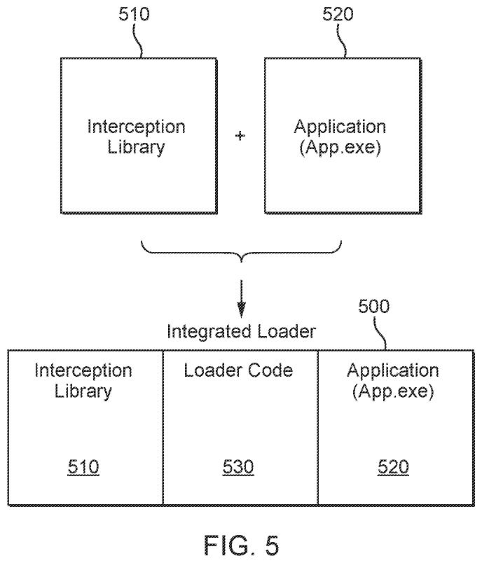

FIG. 5 shows an illustrative block diagram of an integrated loader according to an embodiment. Integrated loader 500 can be a combination of an interception library 510, an application 520, and loader code 530. When integrated loader is run, interception library 510 is first accessed, and then loader 530 is accessed to load application 520 without requiring any external dependencies. When integrated loader 500 is used, the same flow as described above in connection with FIG. 4 is used. That is, when the application makes a call, that call is intercepted by the interception library (and event telemetry is collected) and the original call is executed. Integrated loader 500 can be a custom built loader that does in-place trampolining based on IAT (import address table)/GOT (Global Object Table)/PLT (Procedure Linking Table) fixups. In some embodiments where static binaries are used, integrated loader 500 can execute hunt-and-replace fixups for static binaries as opposed to using load-time fixups.

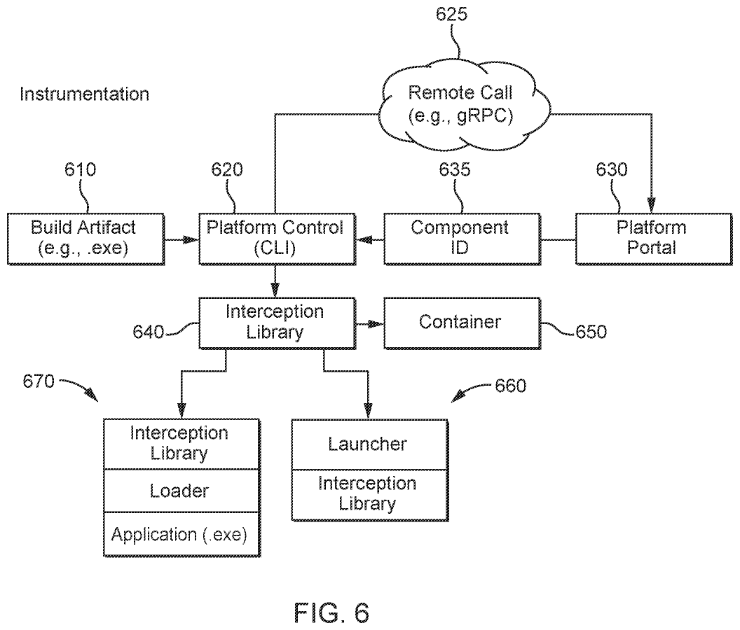

FIG. 6 shows an illustrative block diagram of an instrumentation module or system loading module according to an embodiment. A process called system loading or instrumentation is performed to merge a customer application (i.e., application executable) with the TIAP to produce a new “system loaded” build output. The result is executable code unique to the customer. System loading combines the TIAP runtime (e.g., interception library), the customer build artifact (i.e., customer application), an optional loader, and an optional security policy, and outputs a new binary that is a drop-in replacement for the original customer build output. The replacement executable code is used to provide telemetry collection and optionally, policy enforcement. Customers may also optionally load parts of their application that are not self-built (e.g., system loading a database engine or web server binary is possible). FIG. 6 shows build artifact (e.g., a component binary or the application executable) in block 610, a command line interface in block 620, remote call in block 625, the TIAP portal in block 630, component ID in block 635, interception library in block 640, a container in block 650, a launcher in block 660, and integrated loader in block 670.

The system loader is a program that is built on the TIAP and downloaded by a user to their workstation or build infrastructure machine. The system loader is typically part of a command line interface tool. In some embodiments, command line interface (CLI) tool 620 can be custom built for each customer as it will load components for that customer only. In other embodiments, CLI tool 620 is generic tool provided to each customer that enables the customer to build a different interception library for each application. The TIAP 630 can create the custom CLI tool (containing the system loading function) by using a link kit installed in the portal. The link kit includes a set of object files (.o files) that are linked against a customer-specific object file built on demand (from a dynamic code generation backend placing various statements into a .c file and compiling to an object file). This produces a customer specific CLI tool that contains all information required to produce a binary keyed to the customer that downloaded the CLI tool. This per-customer approach to CLI tool generation eliminates the need for the customer/user to enter many tenant-specific details when loading components. The CLI tool may also contain any SSL certificates or other items required for a secure transaction with the management portal. In other approaches, the SSL certificates can be obtained from an “API token,” which substitutes embedding the SSL certificate into CLI tool 620. The CLI tool can provide several functions: loading, showing/managing applications and components, showing telemetry events, showing audit logs, and showing alerts and metrics At a high level, the CLI tool offers a command line interface to much of the same functionality offered by the web UI provided by the TIAP portal.

During system loading, CLI 620 can receive build artifact 610 and generate interception library 640 by developing interception code for each component in the build artifact 610. The interception code can include telemetry grammars that define which events should be monitored for and recorded. The interception code can also include a trampoline function that transfers the application call to the native library so that the original call by the application is executed as intended. That is for each component of an application, application executable, or build artifact, a TIAP based interception code is generated and included in interception library 640. For example, if first command code is being processed, CLI 620 can send that first command to platform portal 630 via remote call 625. Portal 630 can assign that command a component ID 635 and pass it back down to CLI 620. This way when telemetry events are collected, the component ID will match with the component ID assigned by portal 630. CLI 620 can populate interception library 640 with each component of build artifact 610. When the interception library is complete, CLI 620 can provide the output to container 650, launcher 660, or integrated loader 670. Container 650 can be a class, a data structure, or an abstract data type whose instances are collections of other objects. Launcher 660 is akin to the preloader concept discussed above in connection with FIG. 4. Loader 670 is akin the integrated loader concept discussed above in connection with FIG. 5.

Protection of non-executable artifacts is also possible. To protect interpreted scripts or languages, the system loader can provide a special launcher mode that produces a special binary containing only the TIAP runtime. When using launcher mode, the special binary executes a command of the customer's choice, as if the command being executed was already contained within the output. This allows for scenarios where interpreted languages are used and it is not determinable which interpreter may be present in the target (deployment) machine (as such interpreters may vary between the build environment and the deployment environment).

The CLI tool has various subcommands that are specified on the command line, such as ‘load’, ‘applications’, ‘components’, etc. The load subcommand can run in one of two modes: default and launcher. Each mode produces a different type of output file. In the default mode, which produces an integrated launcher of FIG. 5, the tool takes an input file (a binary file typically produced by the customer's build system or sourced from a trusted ISV), and produces an output file containing TIAP runtime code, customer application executable code (e.g., customer binary), certificates, digital signatures, and telemetry grammar. The CLI tool can contain TIAP runtime code for many different architectures (e.g., amd64, i386, arm32, aarch64, etc.). The specific runtime to choose is determined by the architecture of the customer binary. Certificates can include other identity material for later use in secure communication with the TIAP during execution. The digital signature may be used to avoid tampering (on platforms which support this feature). The Component ID is assigned by the TIAP during the system loading operation and is part of the loaded output. As stated previously, the TIAP runtime is capable of collecting arbitrary telemetry events. The TIAP runtime inserts trampolines into a component based on a set of telemetry grammars that describe which APIs/functions to interpose on. A telemetry grammar can include a code module name (which is name of a native library or other executable code that the API of interest is associated), a function name (which is the name of the function to intercept), and parameter grammars (which can include none or one or more of the following: parameter number (which can include the ordinal position of the parameter (C calling convention (“left-to-right”))), parameter type (which is the data type of this parameter), and parameter size, which is the size of the data, if not known from its type)).

A list of telemetry grammars is built into the loaded component. This occurs at application registration time (e.g., during system loading, when the component and application are being registered with the TIAP). The TIAP can provide a preconfigured set of interesting/well-known telemetry grammars that are automatically available as part of this transaction. Customers can override, customize, or remove any of these grammars using a user interface in a TIAP management portal (or the CLI tool). Customers can also define their own telemetry grammars, if they wish to collect additional telemetries not present in the TIAP common set.

The default set of telemetry grammars is stored in the TIAP's configuration database, and cloned/copied for each customer as they register with TIAP; this allows the customer to make any customizations to the default set they wish, if desired. Each set of customer-specific telemetry grammars are stored with the customer data in the configuration database (albeit separate from the default set or other customers' sets).

In launcher mode, the input is not specified using the -i argument, but rather with a -I (capital I). Launcher mode may be akin to the pre-loader of FIG. 4. This flag indicates that the subsequent command line parameter (after the -I) is to be interpreted as a command line that the runtime will launch. In launcher mode, the customer binary is not embedded with the output. Rather, the system loading process outputs the TIAP runtime code, the component ID, certificates, digital signature, command line, and telemetry grammar. The specific runtime to choose is determined by the -a command line flag. In launcher mode, the TIAP will execute the command specified, and attach itself to the launched process subsequently. Launcher mode is intended for use in scenarios where the customer is reluctant to bundle the runtime code with a 3rd party interpreter (Java, Python, etc.).

If the system loader is being run in default mode and a non-executable file is specified as an input, the system loader will abort and recommend launcher mode instead. If the system loader registers a component that already exists in the TIAP, the system loader will abort and inform the user of this.

During component registration, a set of telemetry grammars will be sent to the system loader from the TIAP. These telemetry grammars contain a list of the libraries and APIs that should be intercepted for this component.

Both system loading modes accept a-t argument that contains a freeform string to be interpreted by the platform as the build time tag. This will typically be a comma separated set of key value pairs that the customer can use to assign any metadata to this component. Note that build time tags are included in the determination of any duplicate components.

The TIAP runtime is executable code that runs at process launch. It is built as position-independent code (PIC) and/or position-independent executable (PIE), and self-relocates to a random virtual address immediately upon startup. The runtime first performs a self-integrity check (to the extent possible considering the platform in use), and then performs a one-time survey/data collection of the following information: platform query, kernel version, memory, CPU (number, type, and speed), NUMA information, distribution information, and network/hardware information. The runtime then performs a transaction with the TIAP portal, sending the aforementioned data as part of a “component start” event. The TIAP portal may reply to this event by (1) proceed with start or (2) do not start. Additionally, the TIAP portal can inform the component that the host software catalogue is out of date by returning such a status code along with the component start event reply.

A host software catalogue is a list of software packages and constituent files on the machine running the component, indexed by hostname and IP address. This information is periodically gathered and uploaded to the TIAP portal to assist with analytics (specifically a common vulnerabilities and exposures (CVE) service). This catalogue is periodically updated, and the TIAP portal will report back out of date if the catalogue does not exist at all, or if the component loading date is later than the last catalogue update time, or if a set age threshold is exceeded (typically set to 1 week by default). If the TIAP portal requests a new catalogue to be uploaded, the runtime will compile the catalogue in a background thread and upload it to the portal when complete (asynchronously, low priority thread). The runtime either then starts the loaded or launched program, or, if the environment DF_EXEC is set, the value of that environment variable's content is used as the launched command line, overriding any -I (launch command) arguments.

On startup, the TIAP runtime can act as a replacement for the system run-time link-editor. The run-time link-editor (“loader”) resolves symbols from required libraries and creates the appropriate linkages. The TIAP runtime can redirect any function names specified in the trampoline grammar to itself, resulting in the creation of a trampoline. A trampoline function takes temporary control over program code flow performs the desired telemetry collection, calls the original function, and then queues an event to the event queue (if the grammar specifies that the API return value or function timing information is to be collected—otherwise the event is sent before the original function is called).

Static binaries pose a different challenge in the sense that there are typically no imports listed in the executable header. The runtime must perform a “hunt and patch” operation, in an attempt to find the corresponding system call stubs that match the function listed in the telemetry grammar. This can involve the following extra steps: searching through memory regions marked executable for system call (syscall) instructions, handling polymorphic syscall instructions (syscall opcodes buried within other instructions; false positives), handling just in time compiled (JITed) code, and handling self-modifying code. JITed and self-modifying code can be detected by mprotect(2) calls-code behaving in this way will be attempting to set the +X bit on such regions. Certain well known languages that output code using these approaches can be handled by out-of-band knowledge (such as hand inspection or clues/quirks databases).

After a customer's product has been configured to operate with the TIAP, telemetry events can be collected. These events can be communicated to the TIAP using an event API. Each “instrumented” component of the customer's application may be able to access the event API to communicate events. The communicated events may be processed by an event service running on the TIAP. The event service can be implemented as a gRPC endpoint running on a server responsible for the component. When the TIAP runtime detects an event of interest, a gRPC method invocation is invoked on the event service. The TIAP runtime knows the server (and consequently, event service) it will communicate with as this information is hardcoded into the runtime during initial loading of that component. Certain common events may occur often (e.g., opening the same file multiple times). In this case, the component may submit a “duplicate event” message which refers to a previous event instead of a completely new event message. This reduces traffic to the server.

The telemetry grammars runtime can define a telemetry level for each component or component instance. The telemetry levels can be set to one of many different levels (e.g., four different levels). Telemetry levels govern the quantity of events and data sent from the instance to the event service in the TIAP portal. Several different telemetry levels are now discussed. One telemetry level may be zero or none that enables the runtime to perform as a passthrough and sends only component start and exit events. Another level may be a minimal level in which the runtime sends only component start events, component exit events, metadata events, and minimal telemetry events. In this level, the runtime only communicates basic information such as the number of file or network operations/etc. Yet another level may be a standard level in which the runtime sends every type of event defined for the minimal level, plus events containing telemetry about the names of files being opened and lists of 5-tuple network connection information. In this level, file events will contain only a file name plus a count indicating the number of times that file was opened. Similarly, this level conveys the list of 5-tuples and a count of how many times that 5-tuple was seen. The standard level also sends event telemetry for the count of each 3rd party API used (count and type). Yet another level is the full level in which the runtime sends all events, including a separate event for each file and network access containing more information about the access, a separate event for each API access, etc. The full telemetry model may buffer events in the instance's filesystem locally before uploading many events in bulk (to conserve network bandwidth).

The telemetry levels can be configured in a variety of different ways. A default telemetry level can be set when the application or component is loaded. If desired any default telemetry level can be overridden at runtime by a runtime tag. The telemetry level can be set by an administrator using the TIAP portal. The administrator can override either of the above settings using a per-instance/component group/application/dashboard setting for the desired telemetry level. Telemetry levels are communicated back to the component multiplexed with the return status code for any event.

The telemetry events can be configured to adhere to a specific message structure. The message structure may be required to interface with the protocol buffers or Interface Definition Language (IDL) used by the event service. Each event can include two parts: an event envelope and an event body. The event envelope can include a header that contains information about the classification/type of the event, and information about the runtime that generated the event. The event body can include a structure containing the event information. This structure is uniquely formatted for each different type of event.

The event envelope can include several different fields. Seven fields are shown in the example pseudocode above. One field is the component_id field. This field includes the universally unique identifier (UUID) of the component making the event submission. This ID is created during system loading and remains constant for the lifetime of the component. Note that there can be multiple component instances with the same component ID. Another field is the event_id field. This is the UUID of the event being submitted. This ID is selected randomly at event creation time. Event IDs can be reused by setting a ‘duplicate’ flag. Another field is the uint64 timestamp field which represents of the number of seconds since the start of a component instance (e.g., standard UNIX time_t format) when the event occurred. Yet another field is the timestamp_us—uint64_t which is a representation of the number of microseconds in the current second since the start of the component instance (e.g., standard UNIX time_t format) when the event occurred. Another field is the duplicate field which is set to true to indicate this event is a duplicate of a previously submitted event, and varies only in timestamp. A build_tag field contains the build time tag assigned to the component submitting the event, if any. A runtime_tag field contains the runtime (environment variable sourced) tag assigned to the component instance submitting the event, if any.

If the duplicate field is set to 1, this indicates that the event with the supplied event_id has occurred again. In this scenario, the event service will ignore any other submitted values in the rest of the message, except for the updated/new timestamp values.

Many different types of telemetry events can be collected. Each of these event types can be processed by the event service running on the TIAP. Several event types are now discussed. One event type is a component start event, which is sent when the component starts. This event includes information about the component, runtime, host platform and library versions, and other environmental data. Component start events are sent after the runtime has completed its consistency checks and surveyed the host machine for infrastructure-related information.

An IDL can describe two enumerations used in this event type: architecture_type and OS. Architecture type is enumerated by a value indicating the platform of the runtime making the event submission. The OS is enumerated by a value indicating the operating system of the runtime making the event submission. The version and os_type fields are freeform strings. For example, on a Windows host, version might be set to “Windows Server 2019”. On a Linux host, version might be set to “5.2” (indicating the kernel version). The os_type on a Linux host might be sourced from the content of lsb_release and might contain “Ubuntu 18.04”, for example. The runtime will calculate the amount of time spent during component startup and report this in the start_time and start_time_us fields. This time represents the overhead induced by the platform during launch.

Another type of event is a component exit event. A component exit event is sent when the component exits (terminates). Component exit events are sent if the component calls exit(3) or abort(3), and may also be sent during other abnormal exit conditions (if these conditions are visible to the runtime). Component exit events have no event parameters or data other than the event envelope.

Another event type is a file event. A file event is sent when various file operations (e.g., open/close/read/write) occur. These are sent for individual operations, when the runtime is in maximum telemetry collection mode. No events are sent on other file operations. File open operations are used to discern component file I/O intent-based on the O_xxx flags to open(2), events may or may not be sent. Exec operations, while not specifically based on open(2), can be sent for components that call exec(3) using a process event.y.

Yet another event type is a bulk file event. A bulk file event can be sent periodically when the runtime is in minimal telemetry collection mode or higher. It can contains a list of files opened plus the count of each open (e.g., “opened/etc/passwd 10 times”). Multiple files can be contained in a bulk file event.

Network events are yet another event type. Network events can be sent when various network operations (e.g., listen/accept/bind) occur. These are sent for individual operations, when the runtime is in maximum telemetry collection mode. Network events can be sent under the following conditions: inbound connections and outbound connections. An inbound connection event can be sent when the component issues a system call (e.g., the bind(2) system call). Outbound Connections—An outbound connection event can be sent when the component issues a connect system call (e.g., connect(2) system call).

The runtime will fill a NetworkEventBody message with the fields defined above. Protocol numbers are taken from a socket system call (e.g., socket(2) system call) and defined in various protocols. The TIAP portal or command line interface is responsible for converting the protocol numbers to readable strings. Address family information is also taken from a system call (e.g., system(2) call) and correspond to AF_* values from socket.h. The local_address and remote_address fields contain up to 16 bytes of local and remote address information (to accommodate large address types such as IPv6). If shorter address sizes are used, the unused bytes are undefined. It should be noted that all fields are populated on a best-effort basis. In certain circumstances, it is not possible for the runtime to detect some of the parameters required. In this case, the runtime will not supply any value for that field (and the field will default to protobuf's default value for that field type).

Bulk network events are yet another type of telemetry events. Bulk network events can be sent periodically when the runtime is in minimal telemetry collection mode or higher. These events can contain a list of 5-tuple network connection events (e.g., connect from local 1.2.3.4:50 TCP to 4.5.6.7:80). Multiple 5-tuple network connection events can be contained in a bulk network event.

Network change events are another example of telemetry events. Network change evens can be sent when an IP address on the machine changes. This event is also sent by the runtime during component start to let the management portal know which IP addresses the system is currently using. Network change events are sent by the runtime when an network change has been detected on the host. This is a periodic/best-effort message and these events may not be delivered immediately upon network state change. Network changes can include addition or removal of an interface, addition or removal of an IP address to an existing interface, or an alteration of a network's media type. A network change event summarizes the current state of all interfaces on the host. This simplifies the logic required by the API and analytics service as only the latest network change event needs to be examined in order to determine the current state, with the slight drawback of having to re-send information for unchanged interfaces.

Memory events are another example of telemetry events. Memory events can be sent when various memory operations (e.g., mprotect/mmap with unsafe permissions) occur. Memory events can be sent when a component attempts to assign an invalid permission to a region of memory. For example, the event may be sent when attempting to set writable and executable memory simultaneously or attempting to set writable permission on code pages. Memory events are not sent for ‘normal’ memory operations like malloc(2) or free(2). This is due to the volume of ordinary memory events that occur with great frequency during normal component operation.

Depending on the type of memory event, the runtime may or may not be able to compute values for all the fields described above. In this case, the default protobuf values for those data types can be used.

Process events are another example of telemetry type. Process events can be sent when process related operations such as fork/exec or library loads occur. The runtime sends a process event when any of the following occur: the process forks using a fork call (e.g., fork(2)), the process executes using any of the exec*(2) or posix_spawn(2) system calls, or the process loads a new library using a open system call (e.g., dlopen(2)). A process event contains an identifier corresponding to the type of event that occurred, with additional information for execute and library load events.

The info field contains value data if event_type is ExecEvent or LibraryEvent. It is undefined for ForkEvent style process events. The info field contains the name of the executed process plus command line parameters for ExecEvent events, and the fully qualified pathname for LibraryEvent events.

Metadata events are another example of a telemetry type. Metadata events can be sent at periodic intervals to update the management portal with information about memory and CPU usage. Metadata events are periodic events sent from the runtime that contain metrics that are counted by the runtime but that might not necessarily result in alerts being generated. Generally, metadata events are events that contain data that do not fit into other event categories. These metrics can include current process memory usage, current OS-reported CPU usage, number of signals received by the process, TIPA runtime overhead (CPU/memory), and total number of events sent to the event service.

It should be understood that the foregoing IDL definitions are not exhaustive and that other event IDL definitions are possible based on telemetry gathered using embodiments discussed herein.

Third party API usage events are another telemetry type and can be sent when the component makes use of a monitored third party API (e.g., typically CSP-provided APIs, like S3, RDS, etc).

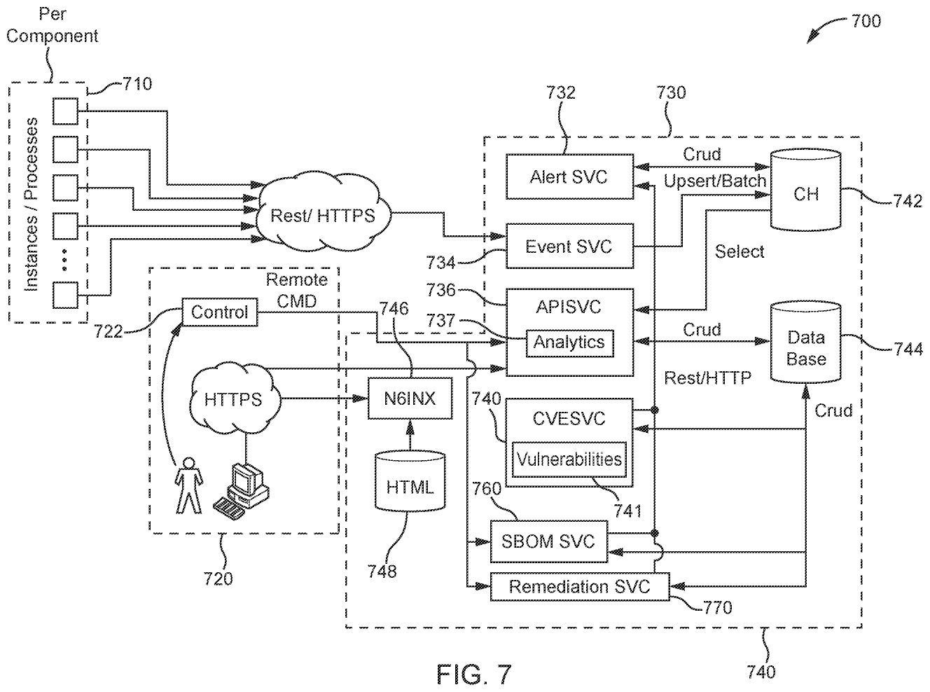

FIG. 7 shows an illustrative block diagram of TIAP 700 according to an embodiment. In particular, FIG. 7 shows instances of one or more components 710 associated with a customer application being run and sending telemetry events, a user interface 720 for interfacing with the TIAP, and backend portion of the TIAP portal 730. The dashed line box 710 can represent one component associated with an application that has a component configured to communicate telemetry events to TIAP portal 730. Each box within dashed line box may represent specific instances or processes for that component. It should be understood that multiple components are typically associated with an application, but only one is shown to avoid overcrowding the drawing. User interface 720 can include, for example, a website based user interface that enables an administrator to access TIAP portal 730. The content of the UI can be delivered by an engine X (nginx) web server (preconfigured in the appliance image if hosted on-premise). The user can interact with a control UI 722 to send remote commands to API service 732 in TIAP portal 730. Example screen shots of different UI screens are discussed in more detail below. TIAP portal 730 can operate several different services, a click house, a postgres (PG), and HTML code. In particular, TIAP portal 730 can include alert service 732, event service 734, API service 736, webapp service 738, CVE service 740, clickhouse 742, databases 744, servicer software 746, and HTML database 748. CRUD represents basic functions of persistent storage, including create, read, update, and delete. REST refers to a representational state transfer that defines a set of constraints.

TIAP 700 can be implemented as a multitenant SaaS service. This service contains all the TIAP platform software components. It is anticipated that some customers may desire to host parts or all of the SaaS portal in their own datacentre. To that end, a single-tenant version of the TIAP portal services can be made available as appliance virtual machine images. For example, the appliance image can be an .OVF file for deployment on a local hypervisor (for example, VMware vSphere, Microsoft Hyper-V, or equivalent), or as an Amazon Web Service Amazon Machine Image (AMI). The appliance images are periodically updated and each deployed appliance can optionally be configured to periodically check for updated appliance code.

API service 736 can implement a core set of APIs used by consumers of TIAP 700. For example, API service may enable user interface 722, a command line application tool, or any customer-written applications that interface with TIAP 700. In some embodiments, API service 736 may function as an API server. API service 736 can be in Node.js using a Sail JS MVC framework. Services provided by API service 736 can be implemented as REST APIs and manage many different types of entities stored in an event database (e.g., clickhouse 742). One such entity can include applications, where service 736 retrieves application information from a primary DB (database 744) based on various parameters (application name, for example). Another entity can be components in which server 736 retrieves component group information from the primary DB (database 744) based on various parameters (component ID, for example). Yet another entity can include instances in which service 736 retrieves instance information from the primary DB (database 744) based on various parameters (component ID and hostname, for example). Another entity can include events in which service 736 retrieves event information from the Events DB (ClickHouse 742) based on various parameters (component or application ID plus event type, for example).

API service 736 can also provide REST APIs to manage alert and insight entities stored in an analytics database (not shown). An alert entity API can retrieve alerts that have been deposited by analytics service 737 into an analytics database (not shown). An insight API can retrieve insights (analysis items) that have been generated by analytics service 737.

API service 736 can also provide REST APIs to manage the entities stored in a CVE database. A CVE API can produce a list of CVEs of components that are vulnerable.

API service 736 can provide provides REST APIs to manage the entities stored in a user database. A users API can provide user accounts, including saved thresholds and filters, and other UI settings. A role API can provide group roles, including role permissions.

REST calls to API service 736 can require an API key. API keys are JWTs (JSON Web Tokens) that grant access to the bearer for a particular amount of time. JWTs generated by the API keys are assigned by the authentication service during logon (for the browser/UI based application) and can also be manually created for use with the CLI (users may do this in ‘Account Settings’ in the UI). If desired, the generation of the JWTs can be performed elsewhere as is known in the art. In addition to the UI and the CLI tool, customers may develop their own applications that interface with the platform. In these scenarios, a “push” or “callback” model is used with the customer's API client (e.g., the application the customer is developing). API service 736 allows for a customer-supplied REST endpoint URL to be registered, along with a filter describing which events the customer's application has interest in. When events of these types are generated, the API server will make a REST PUT request to the customer's endpoint with the event data matching the filter supplied. To safeguard against misconfiguration or slow endpoints causing a potential DoS, successive failures or slow callbacks will result in the callback being removed from the API server, and a log message will be generated in the system log. The API server will also rate limit registration requests. API clients written in this fashion may de-register at any time using the same URL they registered with using the API server's de-registration API. Any registered API client may also be de-registered in the UI (XXX—Where?) or via the CLI tool.

Event Service 734 collects event telemetry from components 710. As explained above, each component has been instrumented to supply telemetry event information to TIAP 700. Upon receiving an event (or multiple events), event service 734 converts the event body into a record that is placed into the Events DB on the ClickHouse 742. Event service 734 can receive events via the Internet.

Analytics Service 737 can periodically survey the events collected by event service 734 and stored in the Events DB and attempts to gather insights based on the events that have been collected. Analytics service 737 is responsible for producing all alerts in the platform, as well as any suggested/remedial corrective tasks. Analytics service 737 gathers events and performs analysis on a continual basis. Analytics service 737 can apply grammars to the collected events to determine whether an alert should be generated. Analytics service 737 can also apply various machine learning models to determine if a pattern of events is detected, and whether this pattern should be alerted. Any insight or alerts that are generated can be stored as a record in the analytics DB (e.g., Postgres 744). The analytics DB is queried by API service 736 when determining if an alert or insight is to be rendered to clients.

CVE Service 740 identifies which CVEs, which identify components having known vulnerabilities 741. CVE service 740 can include CVEs that are created and maintained by TIAP 700. CVE service 740 can use a CVE database, which can be populated from a CVE pack. For example, the CVE database may include a snapshot or copy of various CVE databases that is updated on demand or at regular intervals. CVE service 740 can retrieve a list of CVEs from the CVE database. CVE service 740 periodically scans the event database and determines if any components are vulnerable to CVE. The CVE packs (database dumps) can be created manually by staff operating TIAP 700. This is a manual effort since CVE information is not released/published in a fashion that can be automatically queried. CVE susceptibility can be displayed in a UI hierarchy (e.g., CVE susceptibility is shown based on whatever view is currently active in the UI).

A housekeeping service (not shown) periodically performs cleanup of old data that is no longer required, including audit log data (after archival has been performed or at customer request), old telemetry events (retention time is per-customer specific), old alerts/insights (retention time is per-customer specific), and user accounts that have expired from any linked directory services.

SBOM service 760 can process instances/processes in combination with CVE service 740 to identified components that are used as part of SBOM build of an application and whether any of those components are vulnerable or warrant a priority alert.

Remediation service 770 can locate updated versions of the components found to be vulnerable or categorized as having a priority alert and package the updated versions into a script that can be downloaded and run so that the user can update all the vulnerable components, priority alert components, or combination thereof.

TIAP 700 can maintain several databases in databases 744. An event database can contain all the telemetry received from all loaded applications/components, for all customers. The data in the events database is deposited by the event service and queried by the analytics, CVE, API, and blueprinting services. An insights/alerts database can contain all alerts and insights discovered by the analytics service, as it periodically analyzes data in the events database. Insights/alerts are deposited into the database along with information identifying which component instance (or application) the alert/insight pertains to. An audit log database contains a record of all platform actions performed by a user, for all users in a customer. These entries are generated by the API service as auditable events (changes, etc.) are made using any API offered by the API service. This also includes login/log out events and user profile related events (password changes, etc.). A user database contains information about local users defined for a tenant that are known to the platform. The user database also stores API tokens generated by users that are used by the API service for authentication. A configuration database stores any per-customer configuration information not previously described. This includes any information relating to third party integrations. The configuration database also stores portal-wide configuration used by TIAP systems administrators/operations teams.

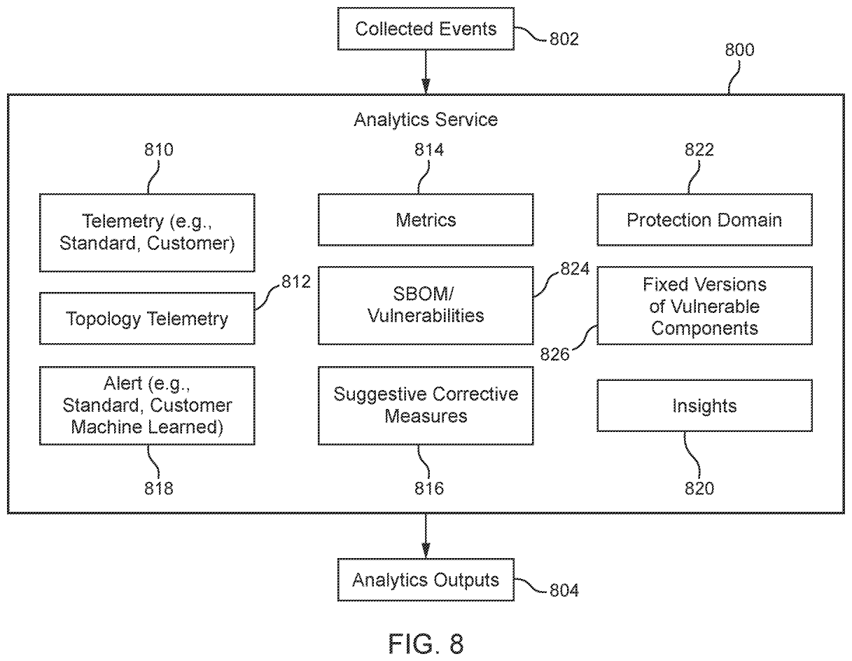

FIG. 8 shows an illustrative block diagram of an analytics service 800 according to an embodiment. Analytics service 800 can analyze collected events 802 and provide outputs 804 based on the analysis performed thereon. Analytics service 800 enables customers to understand the behavior and vulnerabilities of their applications by enabling customers to view in real-time statistics of the execution of their applications and to receive recommended remediation steps to resolve those vulnerabilities and to improve behavior. Analytics service 800 may assist security, operations, and development teams by providing top-down insight into the operation of their applications. The insights may teach the customer how the application is constructed and how it behaves at runtime. Using these insights, customer teams can rapidly deploy updates to their applications to address issues that are identified by the TIAP. In some embodiments, the customer can craft behavioral blueprints (e.g., a policy such as a security policy) that describe the intended behavior of an applications (e.g., how an application should behave, what it should do, and what it should not do). The TIAP runtime can then optionally enforce this sanctioned behavior by applying the blueprint (e.g., security policy) to an application's constituent components.

Analytics service 800 can report insights into application component behavior that deviates from the norm of other similar components. For example, consider an application consisting of 100 identical components (such a configuration is not uncommon in a large microservice-based application). If analytics service 800 determines that an instance suddenly is behaving differently (increased CPU or memory usage, or network traffic) but still is adhering to a security policy or has not triggered an alert, this variance can be reported to the customer in the TIAP portal user interface. Analytics service 800 continually monitors the event telemetry database, and makes periodic decisions as to if an alert or insight is warranted. These decisions are made based on rules defined in the analytics service. Some rules are built into the TIAP portal (such as the standard rules), while others can be customer defined.

Telemetry 810 defines the events that are monitored and collected at the customer's application. Telemetry events have been discussed above and can include standard telemetry grammars and customer generated telemetry grammars. Analytics server 800 may be made aware of which telemetry events are being collected so that it is better able to analyze the collected events. The telemetry events can include, for example, file activity (e.g., what files did the application modify? when? how often did the modifications occur?), network activity (e.g., which hosts did the application accept network requests from? what was the bandwidth of data transferred during those requests? which hosts did the application make outbound connections to?), process activity (e.g., did the application launch any unknown or untrusted processes?), library usage (e.g., what libraries are being used by the application? what is their provenance? are there known security vulnerabilities in the libraries that are being used?), Use of 3rd party APIs—(e.g, is the application accessing 3rd party APIs (such as cloud service provider (CSP) APIs)?, which resources are accessed by the application? are these accesses approved?), and memory activity (e.g., is the application using memory protection in a safe way?). This illustrative list of telemetry events is merely small sample of a much larger set of telemetries that can be collected.

Topology telemetry 812 can capture application composition and topology by monitoring interactions between components of that application. As explained above, an application is composed of several components, and each component is instrumented or loaded so that each instance of each component operation can be monitored and collected. Since components represent the smallest monitorable piece of an application, the TIAP platform's ability to monitor each component enables analytics service 800 the ability to analyze the application as a whole. Moreover, because any given component is typically a single executable or piece of business logic, such as a microservice, or a web server, or a database, the TIAP platform discussed herein is able to assess the application in a very comprehensive manner. Topology telemetry 812 can correlate interactions between components on the backend by analyzing the collected events. This is in contrast with a runtime telemetry that was previously programmed into a telemetry grammar to monitor interactions between the components. For example, topology telemetry 812 may be able to track interactions between application components based typically on IP addresses of hosts running those components. Topology telemetry 812 can be used to assess geographical construction of an application (using GeoIP, if possible). This can provide an additional set of data points when determining the behavior of an application (e.g., which geographies is an application's components communicating with, and are those geographies permissible for the application's current configuration?). If GeoIP information is not available, or unreliable for the specific component in question, the TIAP runtime can query the CSP's instance metadata document to determine in which geography the component is running.

Metrics 814 can define certain metrics that are measured during event telemetry. Metrics are a measurement of a specific quantity or value, observed at a given moment in time. Taken as a collection, metrics can be used to create a trend. Trend lines or graphs are visually represented in the user interface of the TIAP portal. Customers can optionally set a threshold for a trend or metric of interest (for example, alert if the trend of file operations per hour exceeds some preset value). For example, a filesystem metric measures the number of file operations (reads, writes, opens, etc.) per second. It also measures the amount of write I/O that is being performed. As another example, the network metric can measure the number of inbound and outbound connections per second, and bandwidth usage. Metrics for any telemetry can be collected. These metrics can be defined in a metric grammar.

Suggested Corrective Measures 816 is responsible for providing suggestions to improve operation of the application. As event telemetry is collected, it is possible that an application may upload an event that represents a deviation from the expected application behavior. Each deviance from the expected application behavior can generate an alert by alerts 818. Suggestive corrective measure 816 can assess the root cause of the alert and provide a recommendation for fixing it. As events are collected over time, the suggested corrective measures 816 can formulate other suggested changes, for situations that might not warrant an alert. For example, observing application behavior can lead the analytics engine to determine that the order of certain operations is vulnerable to TOCTTOU (time of check to time of use) race conditions. Another example of an insight that analytics service 800 can discern is unsafe use of various system calls (such as mmap/madvise) or changes in the number of system calls issued by or signals received by the application over some set time period. Such information can be presented by suggested corrective measures 816 as non-critical suggested corrective measures or suggested optimization opportunities.

Alerts 818 can define conditions or rules that merit an alert when event telemetries satisfy the rules or conditions. The alert conditions can be predefined a standard set of alerts. The alert conditions can be defined by the customer. In addition, the alerts conditions can be derived from machine learning. The alerts can be categorized according to different levels of alert. For example, there may be four levels of alert, each representing a different degree of severity. Each alert may be labeled according to its level and displayed accordingly in the UI portal. Alerts can be defined by alert grammars that instruct analytics service 800 on how an alert can be recognized, and what the corrective measure there is for that alert (if any). For example, an alert grammar might be described as:

IF MEMORY_PERMISSION=WX OR MEMORY_PERMISSION=RWX THEN ALERT WITH “Dangerous memory permission (writable+executable) used” where MEMORY_PERMISSION is a telemetry event measurement collected by the platform runtime. Note that this is an example grammar to illustrate the concept and is not representative of the real syntax. Alert grammars contain triggers based on metrics, themselves defined by metric grammars. Similar to telemetry and metric grammars, alert grammars are customizable and customer-specific, provisioned from a base set of default grammars.

Insights 820 can define conditions that indicate a potential issue that is identified but does not rise to the level an alert. For example, an insight can be identified when a sudden change occurs with respect to a historical baseline. Insights can be defined with insight grammars, including a standard set of insight grammars and a customer set of insight grammars.

Protection Domain 822 can define high level groupings of events, alerts, metrics, and insights. Protection domains include application operations such as file path access, process execution, network activity, library usage, memory usage, and third party APIs. These Protection domains are abstractions of telemetry events defined by grammars. Such protection domains can be included in a standard set of protection domain grammars. If desired, the customer may customize, delete, or create new protection domains of their own.

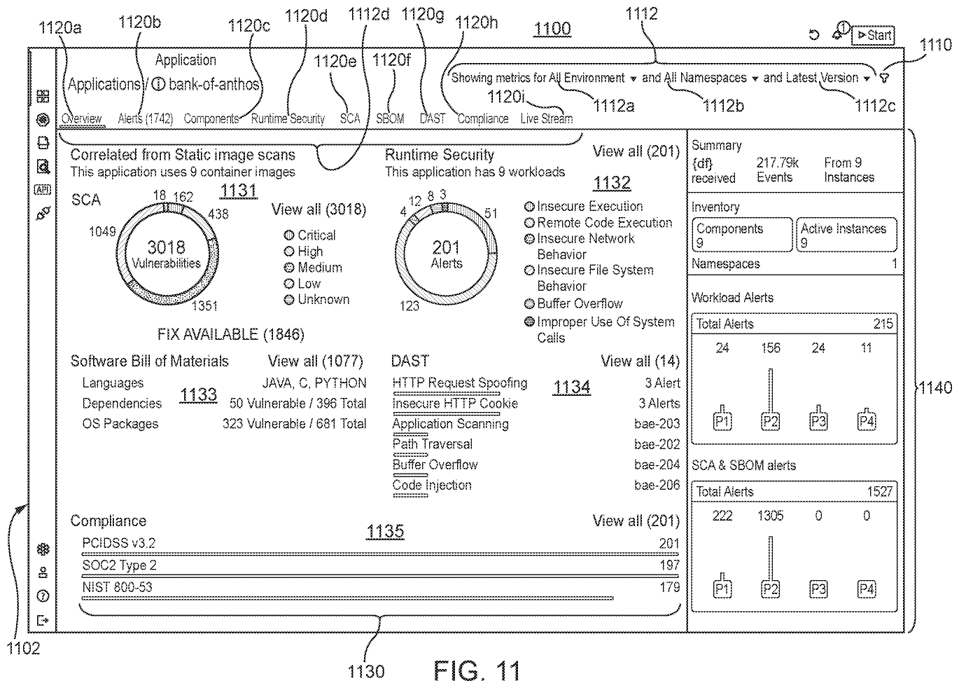

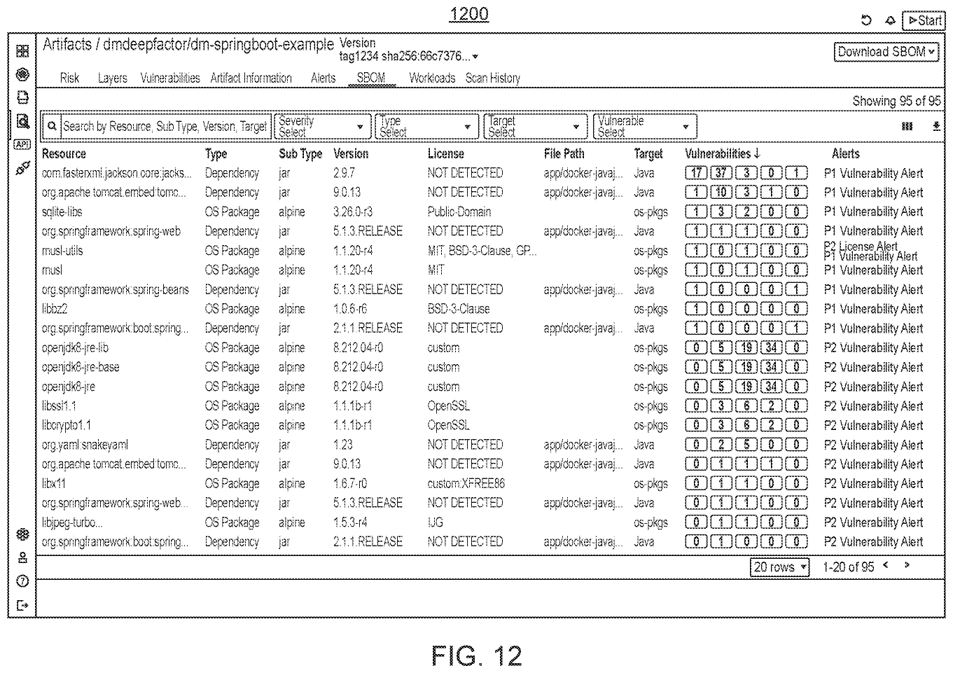

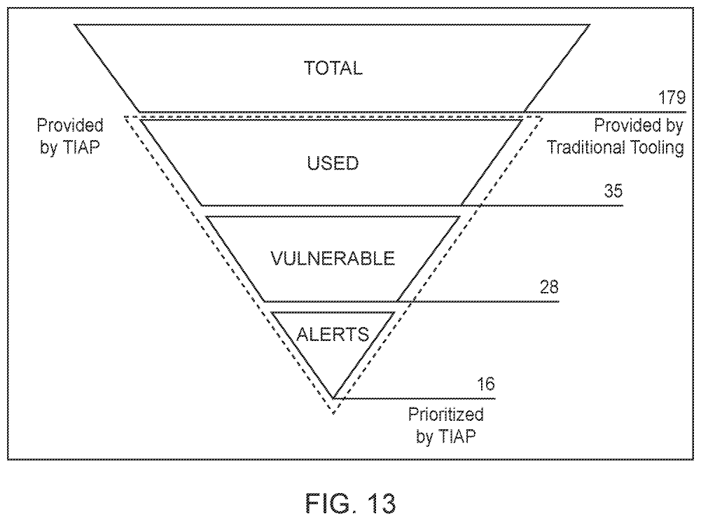

SBOM/Vulnerabilities 824 can define components that are included in the application, components that are used by the application, components that are vulnerable, and vulnerable components that are prioritized as having alert status, similar to what is shown in FIG. 13. The components contained in SBOM/Vulnerabilities 824 may be displayed in a user interface such as that shown in FIGS. 11 and 12.

Fixed versions of vulnerable components 826 can define updates to components that are identified as being vulnerable. Fixed components can be included in a script that is made available to a user for download. When the user downloads the script and it run, the components contained therein can be used to update legacy components being used by the application or container. After the components have been updated, the user can re-run a SBOM/CVE analysis to verify that no further vulnerabilities exist for the application or software image.

The user interface is the primary way in which users interact with the TIAP portal (e.g., portal 730). The UI components can be delivered to the client web browser using an nginx server, which is part of the SaaS backend or appliance. The UI components can be rendered using React locally in the client browser, and interactions with the TIAP portal can be done using a REST-based API exposed by the API service. The user interface may embody several design philosophies. For example, standard views may be provided across multiple levels in the application hierarchy. This ensures that the view remains consistent regardless of what level of the application/component/instance hierarchy is being presented. A time range window can be persistent to enable the user the ability to restrict the current data being presented by start and end times. The UI can include filters to enable user to filter the data being shown (using tags applied to components). For example, a user may choose to filter out all “development” components and only show “production” components by creating suitable filters representing the desired view.

The UI may embody a “drill-down” concept. That is, starting at the highest level, a user may continuously refine their view to embody just what they want to see (via filtering, selecting applications/component groups/instances, and selecting timeline views). The UI can remain as consistent as possible during this refinement. The current level in the hierarchy can be shown to the user with a “breadcrumb” list of previous levels at the top of each view. For example: Dashboard->My App1->Databases->MySQL DB 7. The levels in the breadcrumb are be clickable, allowing users to navigate up the hierarchy as needed. The UI may use several different frameworks, libraries, and components.

Embodiments described herein focus on operationalizing SBOM content. Operationalizing SBOM content may allow engineering teams the ability to block or gate builds based on the accidental importing of problematic modules. For example, that gate may prevent a build from being made if the developer accidentally imported a module whose CVSS vulnerability score is greater than a predetermined threshold. The module may be directly imported, or the module can be imported indirectly or transitively. Operationalizing SBOM content may allow the comparison of multiple SBOMs to ascertain changes between builds, and where vulnerabilities may have been accidentally introduced. Operationalizing SBOM content may provide the ability to handle dynamic dependencies. These dependencies are not known at build time but rather only loaded into the application as needed, when the application is running. Operationalizing SBOM content may also ensure the SBOM contains expected vendor/package information.

Conventional SBOM tools are deficient in many of these areas. While tools now exist to produce basic SBOMs, blocking execution based on SBOM content is not generally something that existing tools do. Furthermore, dynamic dependency handling (including being able to block execution based on dynamic SBOM content) is not handled by any conventional SBOM tool. It should be noted that the embodiments discussed herein extend beyond mere static SBOM generation, as many conventional tools are able to inspect a software product and produce an SBOM based on how the application was built. As will be explained below, SBOM tools according to embodiments herein cover the use and interpretation of SBOM content during the software product's build process, as well as implementing support for dynamic dependencies.

In a typical software build process, 1) a developer implements a certain feature or bugfix; 2) this feature is developer tested (typically on the developer's laptop or desktop); 3) a change request/pull request is issued; 4) the change is reviewed, and if approved, committed to the source code repository; 5) the change proceeds through the automated continuous (CI)/continuous delivery (CD) process (sometime referred to herein as CI/CD pipeline), which may include an automated build test/QA test; and 6) if the test passes, the change is approved and possibly deployed to a staging or production environment. In one embodiment, the SBOM tool adds support for gating (blocking/rejecting) builds based on SBOM analysis. This may be accomplished by inserting the following steps, 4a and 4b, into the above sequence. With additional step 4a, an SBOM is produced, by analyzing the content of the container or environment where the application is running. The artifacts (software modules) discovered during this analysis are uploaded to the TIAP (discussed above) for analysis in later steps described herein. Identifying data about the build itself (e.g., build timestamp/name/etc.) is also supplied to the TIAP for use in SBOM comparison (described below).

With additional step 4b, if the SBOM indicates that vulnerable components are present, the list of vulnerabilities are compared against an administrator (or security team member) supplied alert policy (managed via the TIAP); if the detected vulnerabilities' severity scores exceed the values provided in the alert policy, the build is aborted and a message containing the vulnerabilities that caused the failure is reported to the TIAP for display to the end user. However, if the alert policy specifies that the build should be aborted only if a vulnerable component is actually used, then the build can proceed (optionally with warning about a vulnerable, but unused, component-see step 5a below).

With step 5a, the build test/QA test may optionally include running with a runtime telemetry collection system (discussed above). The runtime telemetry collection system collects information about what resources are used during the build test/QA test, and can be used to further qualify if presence of a vulnerable dependency alone (with or without usage) should imply that the build should be gated. Telemetry about used resources is uploaded to the TIAP periodically and can be used by the TIAP to indicate why a specific build was gated.

With step 5b, the runtime telemetry collection system used in step 5a can also be used to gather dynamic dependencies based on actions performed by the application during run. For example, consider an application that loads different dependencies from the Internet based on user input or type of task being performed; such dependencies cannot be detected in step 4a and can only be detected at the time of usage, which is only possible during runtime analysis. This supplementary list of dependent components can be added to the SBOM gathered during step 4a for a more complete/robust SBOM report. Further, the list of dynamic dependencies can also be used in the build gate decision.

The build gating decision can be made at different points during the CI/CD pipeline, depending on the needs of a user or team. For example, the decision can be made at the time of developer commit (using static SBOM data only) or at the time of build test/QA test (using a combination of static SBOM data and dynamic dependency data). The SBOM tool according to embodiments herein is flexible and can cover both scenarios.

The SBOM tool according to embodiments herein can perform SBOM comparisons and Drift Detection. Referring to step 4a described previously, the TIAP can retain a list of dependencies/modules detected in each SBOM generated. Typically this results in one SBOM for each build. The TIAP can allow the developer to see where a specific vulnerability was introduced by providing the means to compare multiple SBOMs against each other for content. For example, consider two SBOMs with differing content. SBOM #1 contains a list of 100 dependent modules, with no vulnerabilities exceeding the severity score defined in the alert policy mandated by the organization. SBOM #2 contains the same 100 dependent modules, but since it was produced later, it has newer versions of some modules listed. It may be possible that SBOM #2 contains a number of modules that now have vulnerabilities that exceed the defined vulnerability severity score. By comparing these two SBOMs, a visual representation or report of the new vulnerabilities can be shown to the user. Since the TIAP also has build information for each SBOM, the user can be notified specifically which build (or commit) caused the failure.

Note that in the case of build gating, the error described previously would be caught immediately since the build would be aborted and it would be obvious which SBOM/build contained the vulnerable components. The extra capability of this SBOM comparison feature is useful in three scenarios. In a first scenario where builds are not gated SBOMs are generated and stored in the TIAP, but the builds are allowed to proceed even if vulnerable components are detected. In this scenario, older build SBOMs can be compared directly to determine ex post facto which build (in the past) created the vulnerability. This is useful in forensic analysis/breach analysis, should a component prove to be vulnerable after the build was made. In a second scenario where dynamic dependencies are being used, the additional data provided by dynamic dependency analysis can be used to create two or more SBOMs from the same build artifact, provided that the test scenario exercised the application differently (to cause the application to load different dynamic dependencies on each run). In a third scenario that performs a “what if” analysis, the SBOM data from the TIAP is used for comparison, but the alert policy in use changes (e.g., “what if I changed my alert policy to be more strict? Would any of my dependencies fail the test? If so, at which build did those dependencies arrive, and what commit caused those?”).

The SBOM tool according to embodiments herein can perform vendor/package verification. Aside from security vulnerability information, the SBOM gathered in step 4a above can be used to ensure that only modules/dependencies from trusted sources are used. Since SBOMs record information about the dependency's source, a list of trusted sources can be compiled by the system administrator and used to ensure (either at build time or at test time, for dynamic dependencies), that all dependencies are “whitelisted” or come from a trusted source. The package verification gating can also include information from the SBOM's license information. For example, a system administrator can include a rule that says “No component licensed under the GPL is allowed”; if such a package was loaded, the TIAP can indicate this to the user via an alert message.

The SBOM tool according to embodiments herein can perform additional metadata verification. It should be clear that an SBOM contains a rich set of information about a software package. It is also possible to augment the SBOM with information about the level of support a package receives. For example, package information in an SBOM could be augmented with information about the number of active developers contributing to that package, the age or “stale-ness” of the package (how many commits/changes/activities are occurring in that package's source tree), EOL (end of life) information, geopolitical concerns (what country a package was sourced from), and so on. These characteristics can also be made part of the alert policy, allowing administrators to finely control the types of dependencies allowed to be loaded as part of an application.

SBOMs according to embodiments herein can be generated during development utilizing a command-line utility, or during build and test using a webhook to automatically scan container images being deployed into Kubernetes. Such SBOMs can be exported in both CycloneDX and SPDX, complying with the “Minimal Elements” outlined by the Department of Commerce and National Telecommunications and Information Administration (NTIA). For vulnerability information, the TIAP can access many different CVE feeds, and organizes by the version of the container image. These SBOMs can be stored in any number of locations, including within a registry.

The TIAP can automatically discover and prioritize application risks across application code, dependencies, container images, and web interfaces to help developers ship secure code faster. The TIAP not only scans static container images, but also observes running applications or Kubernetes environments, providing detailed usage information, including vulnerability usage, severity, CVSS scores, and license type. With this contextual information, developers can simplify triaging-combating “alert fatigue”-accelerate remediation efforts, and even gate builds that don't satisfy security and licensing policies.

FIG. 11 shows an illustrative GUI page 1100 showing SBOM data and runtime security generated by the TIAP according to an embodiment. GUI page 1100 can include side bar 1102 that includes several user selectable items, top bar 1110 that shows an application being evaluated and associated metrics 1112. Metric 1112 can include metrics for environment 1112a (e.g., shown here for all environments), namespaces 1112b (e.g., shown here for all namespaces), and version 1112c (e.g., shown here for latest version). The user can define the relatively high level metrics that constrain TIAP data presentation. Category bar 1120 can include several different categories that can be selected by a user to further evaluate TIAP data. Category bar 1120 can include overview 1120a, alerts 1120b, components 1120c, runtime security 1120d, software composition analysis (SCA) 1120c, SBOM 1120f, dynamic application security testing (DAST) 1120g, compliance 1120h, and live stream 1120i. As shown in FIG. 11, overview 1120a is selected, which can cause panel field 1130 to be populated with SCA panel 1131, runtime panel 1132, SBOM panel 1133, DAST panel 1134, and compliance panel 1135. Each panel can show a snapshot of data pertaining to its respective categories. Also shown in FIG. 11 is summary panel 1140, which shows a summary of information obtained by the TIAP for the application and selected metrics. The information shown in summary panel 1140 is self-explanatory.

In addition to automatically identifying vulnerable dependencies and packages, the TIAP also generates a dynamic SBOM, in which developers can observe—and be alerted on—file usage, code interactions, resource utilization, license violations, and network behavior to avoid compliance violations and protect against supply chain attacks happening after releasing into production. For example, this could help users identify outbound connections to untrusted geographic regions, secrets being passed into plain text, legacy software development practices, unexpected privilege escalation and/or access to file systems, and use of unapproved license type (e.g., a general public license (GPL)). The TIAP can store this information in a searchable SBOM database to enable rapid response for newly identified critical vulnerabilities (e.g. the next Log 4J) and to provide users with a per-artifact trend analysis across versions and tags. Alert Policies can be tuned as necessary, allowing for user-defined thresholds to determine “what, when, where, how” triggers a response.

FIG. 12 shows an illustrative GUI page 1200 showing SBOM vulnerabilities and types (e.g., dependency or OS package) generated by the TIAP according to an embodiment. Page 1200 may be displayed in response to selection of penal 1133 of FIG. 11. Page 1200 shows more detailed information for the SBOM and ranks each resource in order of vulnerability priority. Page 1200 can organize each item according to resource, type, subtype, version, license, file path, target, vulnerabilities, and alerts.

FIG. 13 shows an example contrasting conventional reporting by a convention system and enhanced SBOM reporting provided by the TIAP according to an embodiment. As shown, conventional tools may report 170 components exist in an application or image container. This is illustrated by the top line item, Total, in FIG. 13. With SBOM operationalization according to embodiments discussed herein, the TIAP can specify how many components were used, which components are vulnerable, and which of those vulnerable components warrant alerts. The TIAP, in contrast, can report much richer and robust information, including for example, “Application deployed 10 containers—5 in NamespaceAl of ClusterA, 3 in NamespaceBl of Clusters, and 2 in NamespaceCl of ClusterC; of the 35 dependencies/packages used by this application, there are only 28 vulnerabilities, of which 16 the TIAP is recommending developers to prioritize based on usage.” This is illustrated by the line items that are enclosed with a dashed line (e.g., Used, Vulnerable, and Alerts), as shown in FIG. 13. The TIAP's report provides a much more comprehensive view of a developer's application, from the static image to the running container, provides developers with valuable information for prioritizing and triaging potential issues.

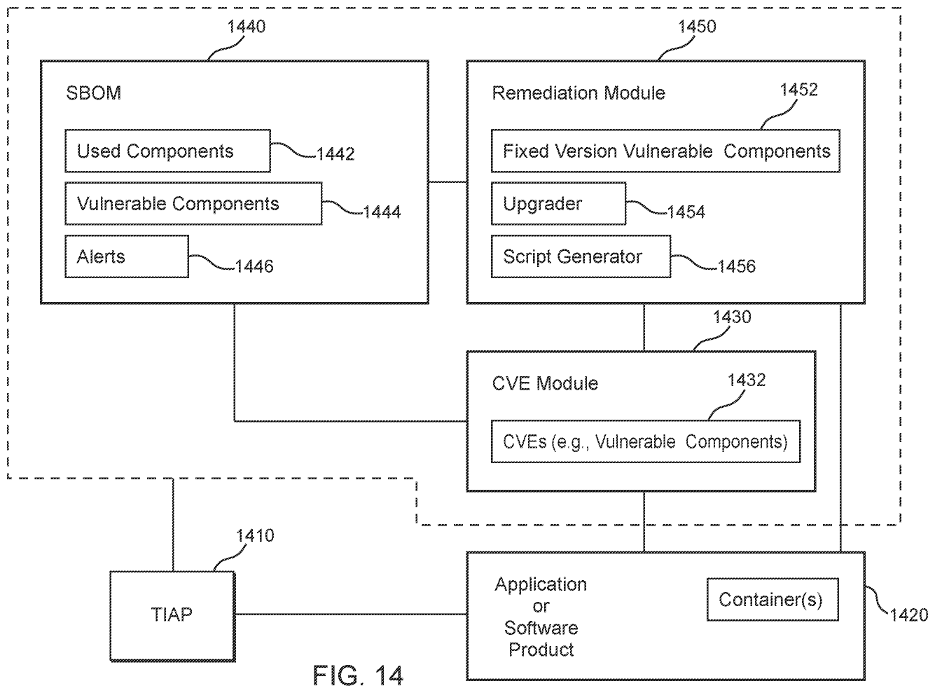

FIG. 14 shows an illustrative block diagram of various modules being used in connection with a TIAP according to an embodiment. In particular, FIG. 14 shows TIAP 1410, application or software product 1420, CVE module 1430, SBOM module 1440, and remediation module 1450. During a TIAP runtime of a container 1422, modules 1430, 1440, and 1450 each perform their respective functions. For example, SBOM module 1430 can identify components used 1432 by the application, components that are vulnerable 1434 based on comparison with CVEs obtained by CVE module 1430, and vulnerable components that merit alerts 1436. This enables SBOM module 1430 to provide SBOM vulnerability guidance that can be prioritized to show which CVEs/vulnerabilities should be resolved in a higher sense of urgency (based on usage of vulnerable components or other criteria).

CVEs 1432 may contain information about what component version a vulnerability can exist. When TIAP 1410 is being used, the TIAP knows which vulnerable component versions are in use, and by virtue of the SBOM/CVE data, the TIAP also possess the information regarding which “fixed in” versions are required to bring the application to a state without any CVEs/vulnerabilities (according to the alert policy defined by the user).

During operation of a TIAP runtime, the TIAP can determine information about the underlying OS/container image (and specifically which package system is being used in the OS/container), a list of vulnerable components (as reported in CVEs against those components), and a list of “fixed in” versions for the vulnerable components. Using this information (as obtained from the TIAP runtime and which provides a blueprint for eliminating vulnerabilities), remediation module 1450 can construct a remediation script that can offer a user a sequence of commands required to remediate the application's vulnerable components. Module 1450 can identify fixed versions of vulnerable components 1452 and generate an update command (e.g., package manager update command) using upgrader 1454 to upgrade the vulnerable component form its current version to the fixed version. For example, upgrader 454 may issue command “apt-get -y upgrade openjdk” or “yum -y upgrade openssl” to upgrade the openjdk and openssl components. Script generator 1456 can consolidate all the upgrade commands into a script that can be provided to a user of the TIAP. The user can download the script and run the script to update all the vulnerable components that have fixed versions available. After the vulnerable components have been updated with their respective fixed version, the TIAP can run SBOM/CVE analysis on the resulting OS/container image to verify that no CVEs exist.

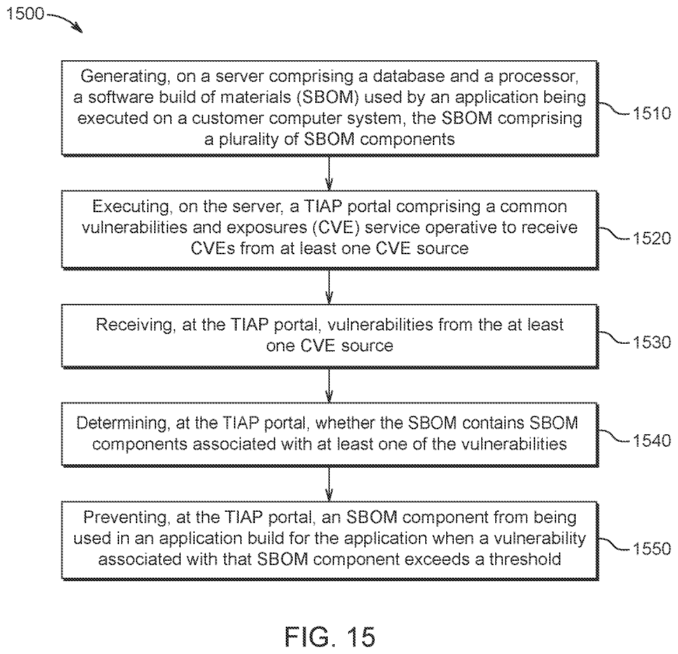

FIG. 15 shows an illustrative process 1500 for evaluating SBOMs according to an embodiment. Starting at step 1510, process 1500 can generate, on a server including a database and a processor, a software build of materials (SBOM) used by an application being executed on a customer computer system, the SBOM comprising a plurality of SBOM components. At step 1520, process 1500 can execute, on the server, a TIAP portal comprising a common vulnerabilities and exposures (CVE) service operative to receive CVEs from at least one CVE source. At step 1530, vulnerabilities can be received from the at least one CVE source. At step 1540, process 1500 can determine, at the TIAP portal, whether the SBOM contains SBOM components associated with at least one of the vulnerabilities. For example, the TIAP can determine if any components used to build the application are vulnerable. At step 1560, process 1500, can prevent an SBOM component from being used in an application build for the application when a vulnerability associated with that SBOM component exceeds a threshold. This protects the application build from using a suspected vulnerability.

It should be understood that the steps shown in FIG. 15 are merely illustrative and that additional steps can be taken, existing steps can be removed, and the order of the steps can be rearranged.

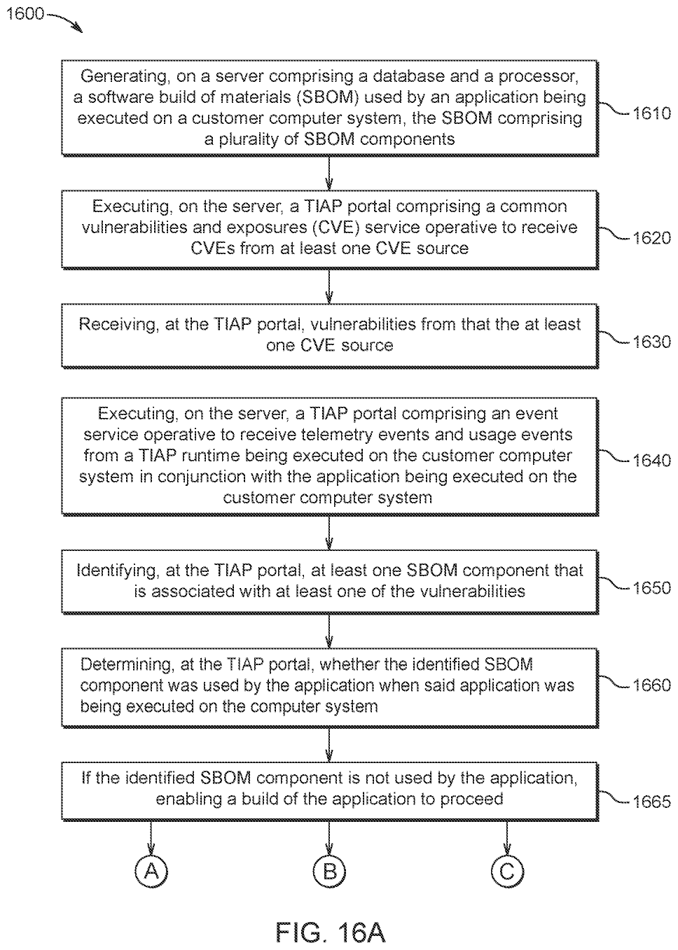

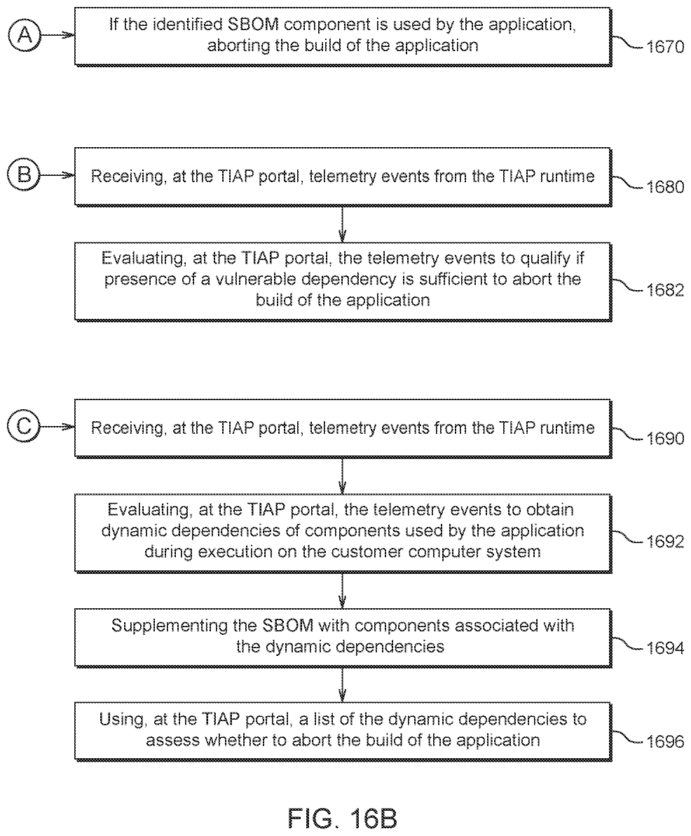

FIGS. 16A and 16B show an illustrative process 1600 for evaluating SBOMs according to an embodiment. Starting at step 1610, process 1600 can generate a software build of materials (SBOM) used by an application being executed on a customer computer system, the SBOM comprising a plurality of SBOM components, and step 1620, can execute a TIAP portal comprising a common vulnerabilities and exposures (CVE) service operative to receive CVEs from at least one CVE source. At step 1630, process 1600 can receive vulnerabilities from that the at least one CVE source. At step 1640, process 1600 can execute a TIAP portal comprising an event service operative to receive telemetry events and usage events from a TIAP runtime being executed on the customer computer system in conjunction with the application being executed on the customer computer system. At step 1650, process 1600 can identify at least one SBOM component that is associated with at least one of the vulnerabilities. At step 1660, process 1600 can determine whether the identified SBOM component was used by the application when said application was being executed on the customer computer system. If the identified SBOM component is not used by the application, process 1600 can enable a build of the application to proceed, at step 1665.

Following step 1665, process 1600 can proceed to step 1670, 1680, or 1690. At step 1670, if the identified SBOM component is used by the application, process 1600 can abort the build of the application.

At step 1680, process 1600 can receive telemetry events from the TIAP runtime and evaluate the telemetry events to qualify if presence of a vulnerable dependency is sufficient to abort the build of the application, at step 1682.

At step 1690, process 1600 can receive, at the TIAP portal, telemetry events from the TIAP runtime and evaluate the telemetry events to obtain dynamic dependencies of components used by the application during execution on the customer computer system, at step 1692. At step 1694, process 1600 can supplement the SBOM with components associated with the dynamic dependencies. At step 1696, process 1600 can use a list of the dynamic dependencies to assess whether to abort the build of the application.

It should be understood that the steps shown in FIGS. 16A and 16B are merely illustrative and that additional steps can be taken, existing steps can be removed, and the order of the steps can be rearranged.

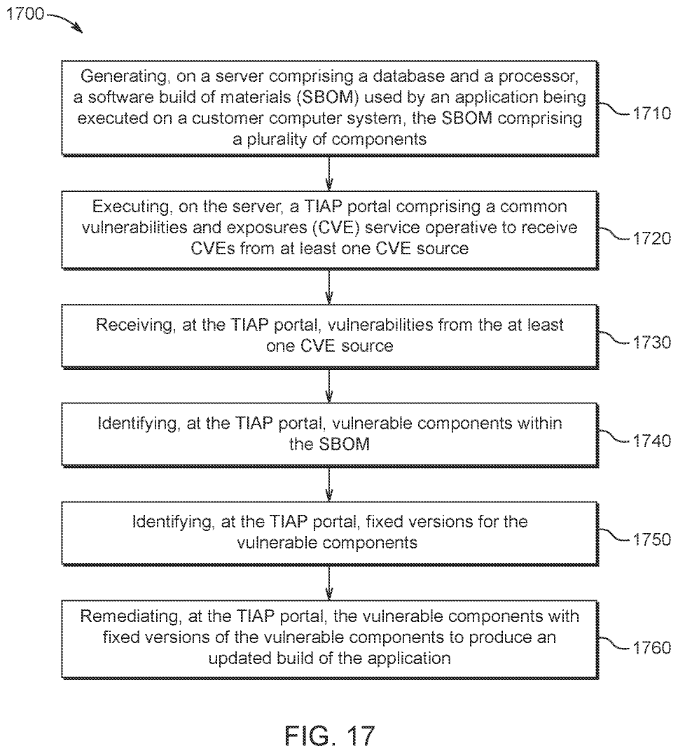

FIG. 17 show an illustrative process 1700 for remediating vulnerable components identified in an SBOM according to an embodiment. Starting at step 1710, process 1700 can generate, on a server comprising a database and a processor, a software build of materials (SBOM) used by an application being executed on a customer computer system, the SBOM comprising a plurality of components. Process 1700 can execute, on the server, a TIAP portal comprising a common vulnerabilities and exposures (CVE) service operative to receive CVEs from at least one CVE source, at step 1720. Process can receive, at the TIAP portal, vulnerabilities from the at least one CVE source at step 1730. At step 1740, process 1700 can identify, at the TIAP portal, vulnerable components within the SBOM, and at stew 1750, can identify fixed versions for the vulnerable components. At step 1760, process 1700 can remediate, at the TIAP portal, the vulnerable components with fixed versions of the vulnerable components to produce an updated build of the application.

It should be understood that the steps shown in FIG. 17 are merely illustrative and that additional steps can be taken, existing steps can be removed, and the order of the steps can be rearranged. For example, update commands can be generated that replace respective vulnerable component with the identified fixed versions thereof and the vulnerable components can be updated by executing the update commands.

In some embodiments, a data processing system may be provided to include a processor to execute instructions, and a memory coupled with the processor to store instructions that, when executed by the processor, may cause the processor to perform operations to generate an API that may allow an API-calling component to perform at least some of the operations of one or more of the processes described with respect to one or more of FIGS. 1-17. In some other embodiments, a data processing system may be provided to include a memory to store program code, and a processor to execute the program code to generate an API that may include one or more modules for performing at least some of the operations of one or more of the processes described with respect to one or more of FIGS. 1-17. In yet some other embodiments, a machine-readable storage medium may be provided that provides instructions that, when executed by a processor, cause the processor to generate an API that allows an API-implementing component to perform at least some of the operations of one or more of the processes described with respect to one or more of FIGS. 1-17. In yet some other embodiments, a data processing system may be provided to include an API-implementing component, and an API to interface the API-implementing component with an API-calling component, wherein the API may include one or more modules or means for performing at least some of the operations of one or more of the processes described with respect to one or more of FIGS. 1-17. In yet some other embodiments, a data processing system may be provided to include a processor to execute instructions, and a memory coupled with the processor to store instructions that, when executed by the processor, cause the processor to perform operations to generate an API-implementing component that implements an API, wherein the API exposes one or more functions to an API-calling component, and wherein the API may include one or more functions to perform at least some of the operations of one or more of the processes described with respect to one or more of FIGS. 1-14. In yet some other embodiments, a data processing system may be provided to include a processor to execute instructions, and a memory coupled with the processor to store instructions that, when executed by the processor, cause the processor to interface a component of the data processing system with an API-calling component and to perform at least some of the operations of one or more of the processes described with respect to one or more of FIGS. 1-14. In yet some other embodiments, an apparatus may be provided to include a machine-readable storage medium that provides instructions that, when executed by a machine, cause the machine to allow an API-calling component to perform at least some of the operations of one or more of the processes described with respect to one or more of FIGS. 1-17.

Moreover, the processes described with respect to one or more of FIGS. 1-17, as well as any other aspects of the disclosure, may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more tasks or that may implement one or more particular abstract data types. It is also to be understood that the number, configuration, functionality, and interconnection of the modules of any one or more of any system device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for operating a telemetry interception and analysis platform (TIAP) system, comprising:
generating, on a server comprising a database and a processor, a software build of materials (SBOM) used by an application being executed on a customer computer system, the SBOM comprising a plurality of SBOM components;
executing, on the server, a TIAP portal comprising a common vulnerabilities and exposures (CVE) service operative to receive CVEs from at least one CVE source;
receiving, at the TIAP portal, vulnerabilities from the at least one CVE source;
determining, at the TIAP portal, whether the SBOM contains SBOM components associated with at least one of the vulnerabilities; and
preventing, at the TIAP portal, an SBOM component from being used in an application build for the application when a vulnerability associated with that SBOM component exceeds a threshold.

2. The method of claim 1, displaying, at the TIAP portal, a message indicating that the application build contains a vulnerable component.

3. The method of claim 1, wherein the threshold is set by an alert policy.

4. The method of claim 1, wherein the SBOM is generated, on the server, by analyzing content of a container or environment wherein the application is being executed.

5. A method for operating a telemetry interception and analysis platform (TIAP) system, comprising:
generating, on a server comprising a database and a processor, a software build of materials (SBOM) used by an application being executed on a customer computer system, the SBOM comprising a plurality of SBOM components;
executing, on the server, a TIAP portal comprising a common vulnerabilities and exposures (CVE) service operative to receive CVEs from at least one CVE source;
receiving, at the TIAP portal, vulnerabilities from that the at least one CVE source;
executing, on the server, a TIAP portal comprising an event service operative to receive telemetry events and usage events from a TIAP runtime being executed on the customer computer system in conjunction with the application being executed on the customer computer system;
identifying, at the TIAP portal, at least one SBOM component that is associated with at least one of the vulnerabilities;
determining, at the TIAP portal, whether the identified SBOM component was used by the application when said application was being executed on the customer computer system; and
if the identified SBOM component is not used by the application, enabling a build of the application to proceed.

6. The method of claim 5, if the identified SBOM component is used by the application, aborting the build of the application.

7. The method of claim 5, further comprising:
receiving, at the TIAP portal, telemetry events from the TIAP runtime; and
evaluating, at the TIAP portal, the telemetry events to qualify if presence of a vulnerable dependency is sufficient to abort the build of the application.

8. The method of claim 5, further comprising:
receiving, at the TIAP portal, telemetry events from the TIAP runtime; and
evaluating, at the TIAP portal, the telemetry events to obtain dynamic dependencies of components used by the application during execution on the customer computer system; and
supplementing the SBOM with components associated with the dynamic dependencies.

9. The method of claim 8, further comprising:
using, at the TIAP portal, a list of the dynamic dependencies to assess whether to abort the build of the application.

10. The method of claim 8, further comprising:
implementing, at the TIAP portal, an abort decision based on the generated SBOM or on the supplemented SBOM.

11. The method of claim 5, further comprising:
comparing, at the TIAP portal, a first SBOM associated with a first build of the application with a second SBOM associated with a second build of the application;
generating, at the TIAP portal, a visual representation of vulnerabilities identified in the comparison of the first SBOM to the second SBOM, wherein the visual representation shows which build introduced a vulnerability.

12. The method of claim 5, further comprising:
performing, at the TIAP portal, vendor or package verification of each component contained in the SBOM to enforce use of trusted sources.

13. A telemetry interception and analysis platform (TIAP) system, comprising:
a server comprising a database and a processor to run a TIAP portal comprising an event service operative to receive telemetry events from a TIAP runtime being executed on a customer computer system in conjunction with an application being executed on the customer computer,
wherein the TIAP portal comprises a common vulnerability and exposure (CVE) service operative to receive a plurality of CVEs, wherein the plurality of CVEs are stored in the database,
wherein the TIAP portal comprises a software build of materials (SBOM) service to:
generate a SBOM used by an application being executed on the customer computer system, the SBOM comprising a plurality of SBOM components;
identify at least one SBOM component that is associated with at least one of the vulnerabilities;
determine whether the identified SBOM component was used by the application when said application was being executed on the customer computer system; and
if the identified SBOM component is not used by the application, enable a build of the application to proceed.

14. The TIAP system of claim 13, if the identified SBOM component is used by the application, the SBOM service is operative to abort the build of the application.

15. The TIAP system of claim 13, wherein the TIAP portal is operative to:
receive telemetry events from the TIAP runtime; and
evaluate telemetry events to qualify if presence of a vulnerable dependency is sufficient to abort the build of the application.

16. The TIAP system claim 13, wherein the TIAP portal is operative to receive telemetry events from the TIAP runtime; and
wherein the SBOM service is operative to:
evaluate the telemetry events to obtain dynamic dependencies of components used by the application during execution on the customer computer system; and
supplement the SBOM with components associated with the dynamic dependencies.

17. The TIAP system of claim 16, wherein the SBOM service is operative to use a list of the dynamic dependencies to assess whether to abort the build of the application.

18. The TIAP system of claim 16, wherein the SBOM service is operative to implement an abort decision based on the generated SBOM or on the supplemented SBOM.

19. The TIAP system of claim 13, wherein the SBOM service is operative to:
compare a first SBOM associated with a first build of the application with a second SBOM associated with a second build of the application;
generating a visual representation of vulnerabilities identified in the comparison of the first SBOM to the second SBOM, wherein the visual representation shows which build introduced a vulnerability.

20. The TIAP system of claim 13, wherein the SBOM service is operative to perform vendor or package verification of each component contained in the SBOM to enforce use of trusted sources.
